(19) United States
(12) Patent Application Publication
(10) Pub. No.: US 2026/0316061 A1
(43) Pub. Date: Oct. 15, 2026

(54) METHOD FOR PREPARING 1T'-TRANSITION METAL DICHALCOGENIDE-BASED HYDROGELS FOR SOLAR-DRIVEN WATER EVAPORATION AND VOCS DEGRADATION

(71) Applicant: City University of Hong Kong, Hong Kong (HK)

(72) Inventors: Hua ZHANG, Hong Kong (HK); Zhiying WU, Hong Kong (HK); Shuai BI, Hong Kong (HK)

(21) Appl. No.: 19/564,259

(22) Filed: Mar. 12, 2026

Related U.S. Application Data
(60) Provisional application No. 63/786,992, filed on Apr. 11, 2025.

(51) Int. Cl. B01J 27/047; B01D 53/86; B01D 53/88; B01J 27/24; B01J 35/39; B01J 35/45; C02F 1/04; C02F 1/14; C02F 1/32; C02F 1/72; C02F 101/22; C02F 101/30; C02F 101/32; C02F 101/34; C02F 103/08; C08F 16/06; C08J 3/07; C08K 3/08; C08K 3/30; C08K 7/00

(52) U.S. Cl. CPC B01J 27/047; B01D 53/8668; B01D 53/885; B01J 27/24; B01J 35/39; B01J 35/45; C02F 1/048; C02F 1/14; C02F 1/32; C02F 1/725; C08F 16/06; C08J 3/07; C08K 3/08; C08K 3/30; C08K 7/00; B01D 2255/104; B01D 2255/20776; B01D 2255/702; B01D 2257/708; C02F 2101/22; C02F 2101/308; C02F 2101/322; C02F 2101/345; C02F 2103/08; C02F 2305/08; C02F 2305/10; C08K 2003/0806; C08K 2003/3009

(57) ABSTRACT

The present invention relates to phase-engineered 1T′-transition metal dichalcogenide (1T′-TMD) hydrogels designed for integrated solar-driven water evaporation and photocatalytic pollutant degradation. The invention utilizes semimetallic 1T′-phase nanosheets as intrinsically active photothermal agents, which possess superior broadband solar absorption and prolonged carrier-lattice energy transfer compared to conventional semiconducting 2H-phase materials. By incorporating these 1T′-TMD nanosheets into a porous hydrogel matrix, the invention effectively reduces water activation enthalpy and enhances interfacial evaporation efficiency. Furthermore, the 1T′-TMDs are coupled with semiconductor catalysts, such as graphitic carbon nitride, to facilitate exceptional charge carrier separation and transport, enabling the simultaneous photodegradation of volatile organic compounds and other water pollutants. This robust platform demonstrates excellent salt tolerance, mechanical durability, and stable freshwater production, offering a scalable and multifunctional solution for next-generation solar desalination and sustainable wastewater remediation.

### CROSS-REFENCE TO RELATED APPLICATIONS

The present application claims the priorities from the U.S. provisional patent application Ser. No. 63/786,992 filed Apr. 11, 2025, and the disclosure of which is incorporated herein by reference in its entirety.

### FIELD OF THE INVENTION

The present invention generally relates to advanced materials for solar-driven energy applications, and more particularly, to phase-engineered 1T′-transition metal dichalcogenide-based (1T′-TMDs) hydrogels and their applications in integrated solar-driven water purification and volatile organic compounds (VOCs) photocatalytic degradation.

### BACKGROUND OF THE INVENTION

Interfacial solar-driven seawater evaporation has emerged as an attractive and sustainable solution to the escalating global freshwater crisis due to its ability to efficiently harness abundant solar energy and its environmental compatibility. Transition metal dichalcogenides (TMDs) have drawn substantial attention in photothermal applications due to their strong solar absorption, unique electronic structures, high surface areas, and cost-effectiveness. Owing to their intrinsic layered crystal structures, TMDs can be synthesized as two-dimensional (2D) nanosheets via top-down techniques such as mechanical or chemical exfoliation. Research efforts using TMD nanosheets for seawater evaporation have often focused on extrinsic modifications, such as heteroatom doping or hybrid composite designs, to enhance light absorption and promote water activation. However, despite rapid progress, the development of scalable and durable solar evaporators is still constrained by limited light absorption and high enthalpy of evaporation.

The crystal phase plays a decisive role in determining the physicochemical properties and photothermal performance of TMDs. Previous studies, such as those by Young-Shin Jun¹ and Wang Xianbao², have explored inducing a phase transition from the semiconducting 2H phase to the metallic 1T phase using lithium intercalation or hydrothermal methods to enlarge sunlight absorption and lower the bandgap. However, these approaches often result in materials with mixed phases, such as 1T/2H MoS₂, and the reported evaporation rates, such as 1.52 kg m⁻² h⁻¹, remain relatively low. Furthermore, 1T-phase TMDs are thermodynamically unstable under ambient conditions and readily revert to the 2H phase, which significantly limits their practical durability. U.S. Patent Application Publication No. 2022/0348476A1³ has attempted to utilize alternative structures, such as the 3R crystal structure, yet the specific photothermal performance of such materials remains unrevealed and uncompared.

Existing technologies also face significant challenges regarding material composition and synthesis. For instance, China Patent Publication No. CN112707391B⁴ focuses on composites of graphene and molybdenum disulfide, but the primary emphasis remains on 2H-phase TMDs and carbon-based materials. While MoS₂-based hydrogels have been proposed in China Patent Application Publication No. CN115746383A⁵, the associated synthesis processes are often quite complicated, hindering scalability. Furthermore, current exfoliation methods for producing nanosheets frequently rely on dangerous organolithium reagents that require inert atmospheres, or electrochemical methods that utilize expensive intercalants and lead to nanosheet agglomeration in water.

Beyond desalination, conventional solar-driven evaporation systems are further hindered by the accumulation of volatile organic compounds (VOCs), which may co-evaporate with water vapor and contaminate the collected condensate. Although photocatalysis has been explored as a strategy to intercept and degrade such VOCs, widely used photocatalysts such as TiO₂ and g-C₃N₄ often suffer from inefficient charge separation and limited carrier transport mobility, thereby restricting their practical performance. Two-dimensional transition metal dichalcogenides (TMDs) have attracted increasing attention as cocatalysts due to their ability to facilitate charge extraction and provide additional active sites. However, most reported TMD-based systems rely on semiconducting 2H-phase materials, whose catalytic activity is typically confined to edge sites and whose intrinsic carrier mobility remains limited.

In contrast, semi-metallic 1T′-phase transition metal dichalcogenides (TMDs) are characterized by relatively higher electronic conductivity and more delocalized electronic states compared with semiconducting 2H-phase TMDs, thereby facilitating improved charge transport and reduced electron-hole recombination. There remains a critical need in the art for stable, high-purity semimetallic materials capable of functioning both as efficient photothermal materials for solar-driven evaporation and as photocatalytic cocatalysts with enhanced electronic transport capability, while also being producible via facile, high-yield, and cost-effective exfoliation processes.

### SUMMARY OF THE INVENTION

The primary object of the present invention is to provide a multifunctional material and a system thereof that can simultaneously achieve high-efficiency solar-driven photothermal water evaporation and photocatalytic degradation of organic contaminants, such as volatile organic compounds (VOCs). Specifically, the invention aims to address the inherent limitations of conventional semiconducting 2H-phase transition metal dichalcogenides (TMDs) and unstable 1T-phases by utilizing phase-engineered, semimetallic 1T′-phase TMDs. By integrating these unconventional nanosheets into a specifically designed hydrogel matrix, the invention provides a durable, scalable, and economically viable solution for sustainable seawater desalination and wastewater remediation.

To achieve the aforementioned objects, the present invention introduces high-purity 1T′-phase TMDs into a hydrogel matrix to form an interconnected porous photothermal system. The technical content involves the synthesis of high-purity 1T′-phase crystals using a salt-assisted method, followed by a high-yield chemical exfoliation process to obtain ultrathin nanosheets. These nanosheets are integrated into the hydrogel at an ultralow loading, typically ranging from 0.5 to 8 wt %. Furthermore, the invention enables the construction of hybrid photothermal-photocatalytic systems by coupling the 1T′-TMDs with semiconductor catalysts like graphitic carbon nitride (g-C₃N₄), facilitating simultaneous steam generation and pollutant interception.

In a first aspect, the present invention provides a photothermal hydrogel for solar-driven water evaporation and pollutant removal. The hydrogel includes a polymer matrix comprising an interconnected porous framework, and semimetallic 1T′-phase transition metal dichalcogenide (1T′-TMD) nanosheets distributed within and anchored to the interconnected porous framework. The 1T′-TMD nanosheets are present in a concentration ranging from 0.5 wt % to 8.0 wt % based on the total weight of the hydrogel.

In one embodiment, the 1T′-TMD nanosheets include a transition metal M and a chalcogen X represented by a formula MX2, where M is selected from the group consisting of tungsten (W) and molybdenum (Mo), and X is selected from the group consisting of sulfur(S) and selenium (Se).

In one embodiment, the 1T′-TMD nanosheets include 1T′-phase tungsten disulfide (1T′-WS₂).

In one embodiment, the 1T′-TMD nanosheets have an average thickness ranging from 0.7 nm to 2.1 nm.

In one embodiment, the polymer matrix is selected from the group consisting of polyacrylic acid, polyvinyl alcohol, polyethylene glycol, sodium polyacrylate, polyacrylamide, polyethyleneimine, polystyrene sulfonic acid, and polystyrene sodium sulfonate.

In one embodiment, the photothermal hydrogel exhibits a solar absorptance of at least 0.9 across a wavelength range from 200 nm to 2000 nm in a dry state.

In another embodiment, the photothermal hydrogel further comprising noble metal nanoparticles decorated on a surface of the 1T′-TMD nanosheets, and further comprising at least one semiconductor catalyst coupled to the 1T′-TMD nanosheets. The noble metal nanoparticles are silver (Ag) nanoparticles having an average particle size distributed between 5 nm and 20 nm.

In another aspect, the present invention provides photocatalytic-photothermal composite system for solar-driven water evaporation and VOCs photodegradation. The system includes a hydrogel matrix comprising semimetallic 1T′-phase transition metal dichalcogenide (1T′-TMD) nanosheets integrated into a cross-linked polymer network; and at least one semiconductor catalyst in direct interfacial contact with the 1T′-TMD nanosheets to form a semiconductor/1T′-TMD heterojunction. The heterojunction promotes charge carrier separation between the semiconductor catalyst and the 1T′-TMD nanosheets, and wherein the semimetallic 1T′-TMD nanosheets function as an electron sink.

The semimetallic 1T′-phase 1T′-TMD nanosheets are configured to act as an electron sink to facilitate charge carrier separation from at least one semiconductor catalyst through a built-in electric field. The composite system is configured to simultaneously perform solar-driven steam generation and photocatalytic degradation of organic contaminants. The system exhibits a photocatalytic degradation efficiency for phenol of at least 90% under 1 sun irradiation for 60 minutes.

In one embodiment, at least one semiconductor catalyst is selected from the group consisting of graphitic carbon nitride, titanium dioxide, zinc oxide, iron oxide, bismuth oxyhalides and cadmium sulfide.

In one embodiment, the weight ratio of at least one semiconductor catalyst to the 1T′-TMD nanosheets ranges from 5:1 to 50:1.

In one embodiment, the organic contaminants include volatile organic compounds (VOCs) selected from phenol, aniline, formaldehyde, benzene, and toluene.

In one embodiment, the system exhibits a photocatalytic degradation efficiency ranging from 80% to 99% for phenol under 1 sun irradiation for 60 minutes.

In another embodiment, the system further comprises further comprising a water supply component arranged to transport source water to the hydrogel matrix via capillary action, wherein the hydrogel matrix is positioned at an air-water interface.

In another aspect, the present invention provides a method for preparing a 1T′-phase transition metal dichalcogenide (1T′-TMD)-based hydrogel, including: (a) synthesizing 1T′-phase crystals by heating a mixture comprising a 2H-phase TMD precursor, a potassium-based salt promoter, and a chalcogen source at a temperature between 700° C. and 900° C. under a reducing atmosphere; (b) exfoliating the 1T′-phase crystals to produce a suspension of 1T′-TMD nanosheets; (c) integrating the 1T′-TMD nanosheets into a hydrophilic polymer solution containing a cross-linking agent to form a mixture; and (d) subjecting the mixture to immediate freezing to form an interconnected submicrometer porous structure while maintaining the semimetallic 1T′-phase.

In one embodiment, the hydrophilic polymer is selected from the group consisting of polyvinyl alcohol (PVA), polyacrylic acid, polyethylene glycol, sodium polyacrylate, polyacrylamide, polyethyleneimine, polystyrene sulfonic acid, polystyrene sodium sulfonate, and combinations thereof. The hydrophilic polymer is provided in the hydrophilic polymer solution at a concentration ranging from 100 mg/mL to 400 mg/mL.

In one embodiment, the exfoliating step is performed by sonication in an acidic solution, the acidic solution comprises H₂SO₄ at a concentration of 0.1 M to 1.0 M.

In one embodiment, the potassium-based salt promoter is selected from the group consisting of potassium oxalate, potassium oxalate monohydrate, potassium carbonate, and potassium bicarbonate, the chalcogen source is selected from the group consisting of sulfur(S) powder and selenium (Se) powder, and the 2H-phase TMD precursor is selected from the group consisting of WS₂ powder, MoS₂ powder, WSe₂ powder, and MoSe₂ powder.

In one embodiment, the salt promoter includes potassium oxalate monohydrate, and the weight ratio of the 2H-phase TMD precursor to the salt promoter to the chalcogen source ranges from 1:0.5:1 to 1:1.5:2.

In one embodiment, the hydrophilic polymer solution includes polyvinyl alcohol (PVA) at a concentration ranging from 100 mg/mL to 400 mg/mL.

In one embodiment, the cross-linking is performed using glutaraldehyde and an acid catalyst, wherein the concentration of the acid catalyst is maintained between 0.02 M and 0.1 M.

In one embodiment, the mixture was immediately placed in a freezer at a temperature ranging from −20° C. to −80° C. and maintained therein for 4 to 12 h.

This invention effectively solves long-standing problems in existing solar evaporation technologies. While conventional photothermal materials suffer from limited solar absorption or rapid phase degradation, the semimetallic nature of 1T′-TMDs ensures intrinsic stability and a broadband solar response. The interconnected porous structure of the hydrogel, facilitated by the 1T′-TMDs, provides efficient water transport and localized thermal insulation, which overcomes the excessive heat dissipation seen in metal-based materials. Most importantly, the high electronic transport capability of the 1T′-phase suppresses electron-hole recombination, solving the issue of sluggish carrier separation that typically hinders the efficiency of 2H-phase TMD photocatalysts.

The present invention delivers significant innovations and unexpected technical effects compared to the prior art. Unlike traditional TMD systems that require complex extrinsic modifications, the 1T′-WS₂ nanosheets act as intrinsically active agents that achieve a high evaporation rate of approximately 3.6 kg m⁻² h⁻¹ and a solar-to-vapor efficiency of 90.0%. Notably, the 1T′-TMD hydrogels demonstrate superior water activation by significantly reducing the water vaporization enthalpy through the enrichment of intermediate water species. Additionally, the invention exhibits an exceptional self-cleaning anti-fouling property, maintaining stable performance under high salinity conditions up to 20 wt % without salt accumulation. When coupled with photocatalysts, the unexpected synergy between the semimetallic phase and semiconductors results in over 98% phenol removal, positioning this technology as a robust platform for next-generation water purification.

### BRIEF DESCRIPTION OF THE DRAWINGS

Embodiments of the invention are described in more details hereinafter with reference to the drawings, in which:

FIG. 1 depicts a schematic diagram of the preparation process of the gel;

FIG. 2A shows the scanning electron microscope (SEM) images of KₓWS₂ crystals and 2H-WS₂ powders; FIG. 2B shows an SEM image of an as-prepared KₓWS₂ flake and corresponding elemental mapping images of W L, S K, and K K signals, as well as the overlapped mapping image thereof; FIG. 2C shows the X-ray diffraction (XRD) patterns of KₓWS₂ crystals and 2H-WS₂ powders; FIG. 2D shows the Raman spectra of KₓWS₂ crystals and 2H-WS₂ powders;

FIG. 3A shows the transmission electron microscope (TEM) images of exfoliated 1T′-WS₂ and 2H-WS₂ nanosheets (NSs); FIG. 3B shows atomic force microscope (AFM) images of exfoliated 1T′-WS₂ and 2H-WS₂ NSs; FIG. 3C shows a high-angle annular dark-field scanning transmission electron microscope (HAADF-STEM) image of a representative 1T′-WS₂ NS, with the corresponding selected area electron diffraction (SAED) pattern shown in the inset;

FIG. 4A shows a TEM image of a representative 2H-WS₂ NS; FIG. 4B shows high-resolution TEM (HRTEM) images of a 2H-WS₂ NS, with the corresponding fast Fourier transform (FFT) pattern shown in the inset;

FIG. 5A shows the Raman spectra of exfoliated 1T′-WS₂ and 2H-WS₂ NSs (a.u., arbitrary units); FIG. 5B shows the X-ray photoelectron spectroscopy (XPS) spectra of exfoliated 1T′-WS₂ and 2H-WS₂ NSs; FIG. 5C shows the K 2p XPS spectra of KₓWS₂ crystals and the obtained 1T′-WS₂ NSs;

FIG. 6A shows the ultraviolet-visible-near-infrared (UV-Vis-NIR) absorption spectra of exfoliated 1T′-WS₂ and 2H-WS₂ NSs; FIG. 6B shows the photoluminescence (PL) spectra of obtained 1T′-WS₂ and 2H-WS₂ NSs;

FIG. 7A shows the transient absorption (TA) pseudo-color plots of 2H-WS₂ NSs and 1T′-WS₂ NSs; FIG. 7B shows the time-resolved TA spectra of 2H-WS₂ NSs and 1T′-WS₂ NSs excited at 380 nm (mOD, milli-optical density);

FIG. 8A illustrates the transient absorption dynamics of 1T′-WS₂ NSs with a pump wavelength of 380 nm and probe wavelengths as indicated; solid lines represent triexponential decay fitting curves convoluted with a Gaussian response function; FIG. 8B illustrates transient kinetics of 2H-WS₂ NSs at 532 nm and 630 nm, and transient kinetics of 1T′-WS₂ NSs at 850 nm;

FIG. 9A depicts the top and side views of a 1T′-WS₂ monolayer with a unit cell outlined in black, and the corresponding element-resolved band structure and projected density of states (PDOS); FIG. 9B depicts the top and side views of a 2H-WS₂ bilayer with a unit cell outlined in black, and the corresponding element-projected band structure and PDOS;

FIG. 10A illustrates the density functional theory (DFT)-calculated optical reflectivity of 1T′- and 2H-WS₂ from monolayer to trilayer and bulk structures; FIG. 10B shows the absorption coefficients of 1T′- and 2H-WS₂ from monolayer to trilayer and bulk structures;

FIG. 11A shows the optical and cross-sectional SEM images of an as-prepared 1T′-WS₂ gel; FIG. 11B shows the optical and cross-sectional SEM images of an as-prepared 2H-WS₂ gel; FIG. 11C shows the SEM characterization of a pure gel, with a photograph thereof shown in the inset; FIG. 11D shows the elemental mapping images of the 1T′-WS₂ gel;

FIG. 12A shows the Fourier transform infrared (FTIR) spectra of 1T′-WS₂ gel, 2H-WS₂ gel, and pure gel; FIG. 12B shows the Raman spectra of 1T′-WS₂ gel, 2H-WS₂ gel, and pure gel; FIG. 12C shows the W 4f XPS spectra of the 1T′-WS₂ gel;

FIG. 13A shows the UV-Vis-NIR absorption spectra of 1T′-WS₂ gel and 2H-WS₂ gel in a wet state; FIGS. 13B and 13C show the transmission and reflection spectra of 1T′-WS₂ gel, 2H-WS₂ gel, and pure gel in a wet state;

FIGS. 14A, 14B, and 14C show the absorption, transmission, and reflection spectra of 1T′-WS₂ gel, 2H-WS₂ gel, and pure gel in a dry state;

FIG. 15 shows the temperature variations of the top surface of wet gels and underlying bulk water under one-sun irradiation as a function of time;

FIG. 16 shows the infrared thermal images of 2H-WS₂ gel and 1T′-WS₂ gel under one-sun irradiation from 0 to 60 minutes;

FIG. 17 shows the mass changes of bulk water, pure gel, 2H-WS₂ gel, and 1T′-WS₂ gel under one-sun irradiation;

FIG. 18 shows the evaporation rates and solar-to-vapor conversion efficiencies of bulk water, pure gel, 2H-WS₂ gel, and 1T′-WS₂ gel under one-sun irradiation;

FIG. 19 shows a comparison of water evaporation rates of TMD-based evaporators featuring different phase structures;

FIG. 20 shows the thermograms of pure gel, 2H-WS₂ gel, and 1T′-WS₂ gel;

FIG. 21A shows in situ the attenuated total reflection Fourier transform infrared (ATR-FTIR) spectra of hydrated 1T′-WS₂ and 2H-WS₂ over time; FIG. 21B shows the Gaussian fitting of O—H stretching bands at 28 seconds, indicating weakly hydrogen-bonded water (3350-3650 cm⁻¹) and strongly hydrogen-bonded water (3200-3350 cm⁻¹);

FIGS. 22A, 22B, and 22C show the IW/FW ratios derived from Raman spectra of bulk water, pure gel, 2H-WS₂ gel, and 1T′-WS₂ gel;

FIG. 23 shows the water evaporation rates of the 1T′-WS₂ gel under varying salinity conditions;

FIG. 24A shows a Raman spectrum of the 1T′-WS₂ gel after a stability test; FIG. 24B shows an XPS spectrum of the 1T′-WS₂ gel after a stability test;

FIG. 25A illustrates the compressive deformation of the 1T′-WS₂ gel at a maximum compressive strain of 90%; FIG. 25B shows the stress-strain curves over 50 loading-unloading cycles at a maximum compressive strain of 50%, with insets showing the gel before and after the 100th loading cycle;

FIGS. 26A, 26B, and 26C show the SEM, TEM, and Raman characterizations of 1T′- and 2H-phase MoS₂, MoSe₂, and WSe₂ materials;

FIGS. 27A, 27B, and 27C show the absorbance spectra, mass changes, and water evaporation rates of 1T′- and 2H-phase TMD hydrogels (WSe₂, MoS₂, MoSe₂) under one-sun illumination;

FIG. 28A depicts a schematic diagram of a water-collecting device; FIG. 28B shows a photograph of the water-collecting system in outdoor practical application;

FIG. 29 shows the temporal variations of ambient temperature, solar flux, hourly water collection rate, and cumulative water yield during daytime operation;

FIG. 30 shows an infrared thermal image of the 1T′-WS₂ gel during operation;

FIG. 31 shows the concentrations of major cations and anions in seawater before and after purification;

FIG. 32 shows the heavy metal removal performance of the 1T′-WS₂ gel before and after solar distillation;

FIG. 33 shows the UV-Vis spectra of methyl orange and methylene blue aqueous solutions before and after solar distillation, with corresponding photographs shown in the insets;

FIG. 34A shows an HRTEM image and energy-dispersive spectroscopy (EDS) elemental mapping of a 1T′-WS₂/g-C₃N₄ composite; FIG. 34B shows the XPS spectra comparison between g-C₃N₄ nanosheets and the 1T′-WS₂/g-C₃N₄ composite;

FIGS. 35A and 35B show the FTIR and Raman spectra of 1T′-WS₂/g-C₃N₄ and 2H-2H-WS₂/g-C₃N₄ composites; FIG. 35C shows the transient photocurrent (i-t) response curves; FIG. 35D shows the Nyquist plots of a setup used for solar evaporation and phenol degradation in a closed system; FIG. 35E shows the PL spectra of the same setup; FIG. 35F shows a schematic diagram of the setup; FIG. 35G shows the comparison of phenol removal efficiencies of 2H-WS₂ gel, 1T′-WS₂ gel, 2H-WS₂/g-C₃N₄ gel, and 1T′-WS₂/g-C₃N₄ gel; FIG. 35H shows a mass change curve of the 1T′-WS₂/g-C₃N₄ gel under one-sun illumination;

FIGS. 36A, 36B, and 36C show the absorption, transmission, and reflection spectra of 1T′-WS₂ gel, 2H-WS₂ gel, and pure gel in a wet state; and

FIGS. 37A, 37B, and 37C show the absorption, transmission, and reflection spectra of 1T′-WS₂ gel, 2H-WS₂ gel, and pure gel in a dry state.

### DETAILED DESCRIPTION

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to =1%, less than or equal to ±0.5%, less than or equal to =0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “1T′-phase” refers to a distorted octahedral coordination geometry of a transition metal dichalcogenide (TMD), characterized by a broken symmetry relative to the ideal 1T structure. This phase typically exhibits semimetallic electronic properties and involves a periodic lattice distortion resulting in metal-metal bonding chains (e.g., W-W chains in WS₂).

The term ‘transition metal dichalcogenide’ or ‘TMD’ refers to a class of two-dimensional materials with the chemical formula MX2, where M is a transition metal atom (e.g., W, Mo) and X is a chalcogen atom (e.g., S, Se, Te). The structure consists of an individual layer of M atoms sandwiched between two layers of X atoms.

The term “semimetallic” refers to an electronic structure characterized by a small overlap between the bottom of the conduction band and the top of the valence band, resulting in no energy bandgap. This property facilitates high carrier density and broadband optical absorption across the solar spectrum.

The term “interfacial junction” refers to the physical and electronic contact area formed between the 1T′-TMD nanosheets and the semiconductor catalyst. This junction is configured to create a built-in electric field that drives the separation of photo-generated electron-hole pairs.

The term “electron sink” refers to a material or structural component within a photocatalytic system that possesses a high electron affinity or work function, enabling it to capture and store photo-generated electrons from a coupled semiconductor, thereby suppressing charge carrier recombination.

The term “interconnected porous framework” refers to a three-dimensional network structure within the polymer matrix characterized by an array of open pores that are physically linked to one another, allowing for continuous fluid transport via capillary action throughout the bulk of the hydrogel.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

In the following description, 1T′-TMDs, the improved exfoliation method, and their specific applications in photothermal water evaporation and photocatalytic degradation systems are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Solar interfacial steam generation is an attractive route for seawater desalination and wastewater purification, yet its efficiency remains limited by the weak photothermal response and poor water activation of conventional materials.

The present invention provides a comprehensive platform for the synthesis and application of 1T′-phase transition metal dichalcogenide (1T′-TMD) hydrogels specifically engineered for high-efficiency solar-driven water purification and environmental decontamination. To overcome the thermodynamic instability and synthesis challenges associated with conventional metallic TMD phases, the invention utilizes a novel, one-pot salt-assisted strategy to produce stable, high-purity 1T′-phase crystals. This method allows for precise phase control by embedding specific ions (e.g., K⁺) into the interlayer spaces, thereby stabilizing the distorted octahedral (1T′) coordination and enabling the production of semimetallic materials with superior electronic properties.

Furthermore, the invention introduces an efficient and scalable chemical exfoliation method that utilizes simple sonication in an acidic medium to delaminate the 1T′-phase crystals into monolayer or few-layer nanosheets. This process addresses the critical industry limitation of low exfoliation yields typically found in semiconducting 2H-phase TMDs.

In one embodiment, the high-purity 1T′-phase TMD crystals are synthesized using a salt-assisted method. A mixture comprising 2H-phase TMD precursor powders, a salt promoter (such as potassium oxalate monohydrate), and a chalcogen source (such as sulfur or selenium powder) is prepared, preferably in a molar ratio of approximately 1:1.1:10. The synthesis is conducted in a controlled environment, such as a tube furnace, under a reducing atmosphere (e.g., H₂/Ar mixture) at a temperature ranging from 700° C. to 900° C., typically 800° C., for a duration sufficient to ensure phase transformation.

In another embodiment, the 1T′-TMD NSs are produced by sonicating the as-synthesized crystals in an acidic solution, such as 0.5 M H₂SO₄, which facilitates interlayer expansion and delamination. This chemical exfoliation method achieves a significantly higher yield, reaching up to 90.8%, compared to conventional 2H-phase exfoliation. The resulting suspension is purified via multiple centrifugation steps to isolate high-quality, ultrathin nanosheets with average thicknesses of approximately 1.1 nm.

In one embodiment, the 1T′-TMD utilized in the present invention includes, but is not limited to, 1T′-phase tungsten disulfide (1T′-WS₂), 1T′-phase molybdenum disulfide (1T′-MoS₂), 1T′-phase molybdenum diselenide (1T′-MoSe₂), 1T′-phase tungsten diselenide (1T′-WSe₂), and combinations or derivatives thereof. The 1T′-TMD materials are characterized by a semimetallic electronic structure with distorted octahedral coordination, which provides intrinsic advantages in broadband solar absorption and efficient carrier transport compared to conventional semiconducting 2H-phase counterparts.

For instance, ultrathin 1T′-WS₂ nanosheets are successfully exfoliated by directly sonicating the parent KₓWS₂ crystals in a diluted acidic medium such as H₂SO₄. This chemical exfoliation process leverages the increased interlayer spacing within the KₓWS₂ crystals facilitated by the presence of residual K⁺ ions from the salt assisted synthesis. These residual ions promote effective delamination by allowing superior solvent penetration during sonication. Consequently, the invention achieves an unexpectedly high exfoliation yield of approximately 90.8%, representing a more than 100 fold increase compared to the 0.83% yield obtained from 2H-WS₂ control powders under identical conditions. Such a high yield and scalable approach ensures a consistent supply of intrinsically active photothermal agents that remain uniformly dispersible in aqueous environments. This facilitates their seamless integration into multifunctional hydrogel matrices for simultaneous water evaporation and pollutant degradation.

Furthermore, the 1T′-TMD nanosheets of the present invention may comprise ternary or quaternary alloys of transition metals and chalcogens, represented by the general formula MS₂ₓSe₂₍₁₋ₓ₎, where M is a transition metal such as W or Mo, and x ranges from 0 to 1. These phase-engineered materials may further include residual ions, such as potassium ions (K⁺), situated within the interlayer spaces, which stabilize the 1T′ crystal structure and facilitate high-yield exfoliation into monolayer or few-layer nanosheets. Such high-purity 1T′-TMDs remain uniformly dispersible in both aqueous and organic solvents, ensuring their versatile integration into various hydrogel matrices for synergistic water purification and pollutant degradation.

The integration of semimetallic 1T′-TMD nanosheets into hydrogel systems significantly enhances solar absorption across a broadband wavelength range from 200 to 2000 nm, attributed to their unique electronic and structural properties such as long-lived carrier absorption. Compared to traditional semiconducting 2H-phase counterparts, these 1T′-TMD based gels exhibit superior photothermal conversion efficiency and accelerated water evaporation rates, even with an ultralow nanosheet loading of approximately 0.26 wt %. Furthermore, the interconnected porous structure of the hydrogel matrix, facilitated by the 1T′-TMDs, effectively prevents salt accumulation and surface fouling under high salinity conditions up to 20 wt %. These synergistic photothermal and structural characteristics render the 1T′-TMD hydrogels highly effective for advanced solar-driven water purification and environmental remediation applications.

In one embodiment, the hydrogel system of the present invention comprises a polymer matrix configured to host the 1T′-TMD nanosheets. The polymer matrix may be selected from a group consisting of polyvinyl alcohol (PVA), polyacrylic acid, polyethylene glycol, sodium polyacrylate, polyacrylamide, polyethyleneimine, polystyrene sulfonic acid, or a combination thereof. The polymer matrix serves multiple critical functions: it provides a robust interconnected porous framework that facilitates rapid water capillary transport; it offers thermal insulation to confine heat at the evaporation interface; and it effectively anchors the 1T′-TMD nanosheets to prevent agglomeration. In some embodiments, the concentration of the polymer in the precursor solution ranges from 100 g/L to 300 g/L.

In some embodiments, the concentration of the 1T′-TMD nanosheets in the hydrogel ranges from 0.5 wt % to 8.0 wt %, preferably from 0.1 wt % to 3.0 wt %.

In some embodiments, the 1T′-TMD-based hydrogel is configured for applications selected from seawater desalination, industrial wastewater treatment, heavy metal recovery, solar-driven sterilization, and thermoelectric power generation.

In another aspect, the present invention provides a multifunctional hybrid system by coupling the 1T′-TMDs with at least one semiconductor catalyst to enable simultaneous solar-driven evaporation and photocatalytic degradation of pollutants. The semiconductor catalyst may include, but is not limited to, graphitic carbon nitride (g-C₃N₄), titanium dioxide (TiO₂), zinc oxide (ZnO), iron oxide (Fe₂O₃), or cadmium sulfide (CdS).

In one embodiment, the amount of the semiconductor catalyst ranges from 100 mg to 500 mg. The semimetallic 1T′-phase acts as a high-mobility electron sink, forming a built-in electric field with the semiconductor catalyst to suppress electron-hole recombination and significantly boost the degradation efficiency of pollutants such as VOCs, industrial dyes, and pesticides.

In another aspect, the present invention provides a method for preparing 1T′-TMD-based hydrogels, comprising the following steps:
(a) Synthesis of 1T′-Phase crystals: mixing a 2H-phase TMD precursor, a salt promoter, and a chalcogen source, followed by heating the mixture in a controlled atmosphere to induce phase transformation into high-purity 1T′-phase crystals;
(b) High-yield exfoliation: dispersing the as-synthesized crystals in an acidic solution and applying sonication to delaminate the crystals into monolayer or few-layer 1T′-TMD nanosheets;
(c) Hydrogel integration: introducing the exfoliated nanosheets into a polymer solution, followed by adding a cross-linking agent and an initiator to form a hydrogel matrix through a gelation process;
(d) Phase-controlled solidification: subjecting the resulting mixture to at least one freeze-thaw cycle to establish an interconnected porous structure while preserving the semimetallic phase of the TMD nanosheets.

The exfoliation yield of the 1T′-TMD nanosheets is at least 80% relative to the total mass of exfoliated nanosheets obtained from the 1T′-phase crystals.

### EXAMPLE

### Example 1—Materials and Methods

Synthesis of 1T′-KₓWS₂ crystals

The synthesis of 1T′ TMD crystals, such as 1T′-KₓWS₂, is performed via a salt-assisted thermochemical process. A precursor mixture is prepared by combining 2H-phase TMD powder, a salt promoter (e.g., K₂C₂O₄·H₂O) and a chalcogen source (e.g., S powder). The weight ratio of the 2H-phase TMD powder to the salt promoter to the chalcogen source ranges from 1:0.5:1 to 1:1.5:2. The mixture is ground to achieve uniformity and then subjected to thermal treatment in a reaction chamber. The environment is preferably purged of air using an inert gas. The reaction is conducted at a temperature ranging from 700-900° C. (preferably approximately 800° C.) and kept for 2-6 hrs under a reducing atmosphere, such as a H₂ (30%)/Ar (70%) mixed gas.

After cooling, the resultant product is washed with deionized water until reaching a substantially neutral pH (e.g., pH 6.0 to 8.0). The product may be further immersed in water and subsequently dried to yield high-purity 1T′-phase crystals.

Preparation of 1T′-WS₂ NSs and 2H-WS₂ NSs

For the synthesis of 1T′-WS₂ NSs and 2H-WS₂ NSs, the as-prepared KₓWS₂ crystals and 2H-WS₂ powder were dispersed in an acidic solution such as H₂SO₄ solution. In some embodiments, the concentration of the acidic solution ranges from 0.1 M to 5.0 M (e.g., approximately 0.5 M). The resulting mixture is subjected to sonication for a duration sufficient to induce delamination, typically ranging from 5 to 30 minutes. In a preferred embodiment, the sonication is performed at a relatively low power setting to preserve the large lateral size and semimetallic phase integrity of the nanosheets. Following sonication, the suspension undergoes a multi-stage purification process to isolate high-quality nanosheets. In one embodiment, the process comprises: (a) Solvent Exchange: The suspension is centrifuged at a high speed, for instance between 8,000 and 15,000 rpm (e.g., approximately 10,000 rpm), followed by replacing the acidic supernatant with deionized water (e.g., Milli-Q water); and (b) Size Selection: The resulting suspension is further centrifuged at a lower speed, for instance between 1,000 and 3,000 rpm (e.g., approximately 2,000 rpm). The supernatant containing the exfoliated monolayer or few-layer nanosheets is collected, while unexfoliated or partially exfoliated sediments are removed.

Preparation of 1T′-WS₂ Gel, 2H-WS₂ Gel, and Pure Gel

The fabrication of 1T′-phase TMD hydrogels involves the integration of exfoliated nanosheets into a cross-linked polymer network. A polymer solution is first prepared by dissolving a hydrophilic polymer, such as polyvinyl alcohol (PVA), in an aqueous medium. In some embodiments, the concentration of the polymer solution ranges from 100 to 400 mg/mL (e.g., approximately 150 mg/mL), achieved by heating the mixture (e.g., at 90° C. to 100° C.) until fully dissolved. The gelation process is initiated through the addition of a cross-linking agent. In one embodiment, a cross-linking agent such as glutaraldehyde (GA) is introduced into the polymer solution. The mixture is typically subjected to mechanical stirring and sonication for a duration sufficient to ensure uniform distribution of the components. To achieve simultaneous photothermal functionality and structural integrity, 1T′-TMD nanosheets and an acid catalyst, such as hydrochloric acid (HCl), are incorporated into the mixture, wherein the concentration of the acid catalyst is maintained between approximately 0.02 M and 0.1 M in some embodiments. The resulting precursor solution is subsequently subjected to a solidification and structural formation process, which comprises maintaining the solution at an ambient temperature for a duration sufficient to allow the formation of a cross-linked network, such as an overnight gelation period. Following the initial gelation, the resulting hydrogel is immersed in a solvent, such as deionized water, to facilitate solvent exchange and swelling, thereby removing unreacted species and attaining a desired porous structure and degree of hydration prior to characterization or application.

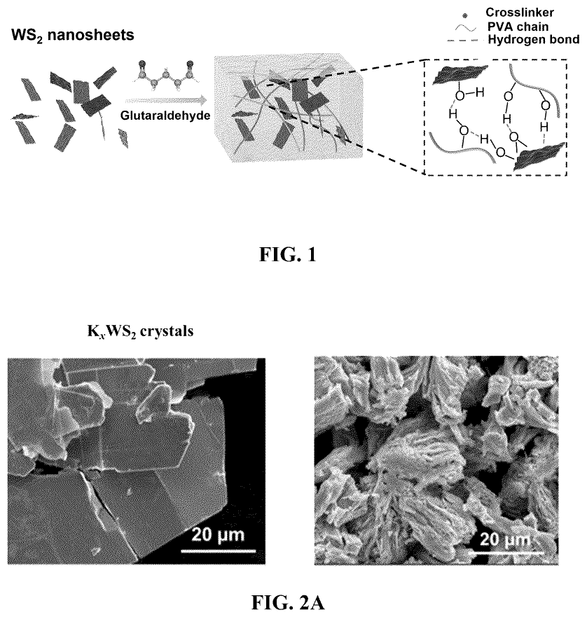

As shown in FIG. 1, 15 mg mL⁻¹ aqueous polyvinyl alcohol (PVA) solution was prepared by dissolving 0.3 g of PVA in 20 mL of deionized (DI) water at 95° C. for 1 hour. To initiate crosslinking, 12.5 μL of glutaraldehyde solution was introduced into 10 mL of the PVA solution within a silicone vessel. The mixture was stirred magnetically for 5 minutes, followed by 10 minutes of sonication in a bath sonicator. Next, 40 μL of 1.2 M HCl solution and 1 mL of 1T′-WS₂ suspension were added and stirred for 2 minutes to ensure uniform dispersion. The solution was then placed under room temperature overnight and subsequently thawed by immersion in DI water at room temperature. The resulting hydrogels were then swelled in DI water before being utilized for further characterization and applications. For comparison, the same procedure was applied to prepare 2H-WS₂-based hydrogel (2H-WS₂ gel).

### DFT Calculations

All first-principles calculations based on DFT were conducted using the Vienna Ab Initio Simulation Package (VASP). To account for van der Waals interactions between the WS₂ layers, the dispersion correction D3 method of Grimme was employed. The generalized gradient approximation with the Perdew-Burke-Ernzerhof functional (GGA-PBE) was utilized. Electron-ion interactions were tested using the projector augmented wave (PAW) method. An energy cutoff of 400 eV was applied. For the optical properties, self-consistent calculations were terminated when the energy variation fell below 10⁻⁸ eV. Spin-orbit coupling (SOC) was explicitly included in all calculations to account for relativistic effects on the electronic structure and optical transitions. The optical properties were derived from the frequency-dependent dielectric function obtained from the random phase approximation. The Brillouin zone was sampled with a Gamma-centered k-point grid, corresponding to a reciprocal space resolution of 2π×0.025/Å. The optical properties were processed by VASPKIT. The AIMD simulations were carried out at 300 K in NVT ensemble with a Nosé-Hoover chain thermostat, and the time step was set to 1 fs. The density of hydrogen bonds against bond length and distance to the surface was evaluated by the kernel density estimation using a Gaussian-type kernel.

### Example 2—Characterization of 1T′-WS₂ NSs and 2H-WS₂ NSs

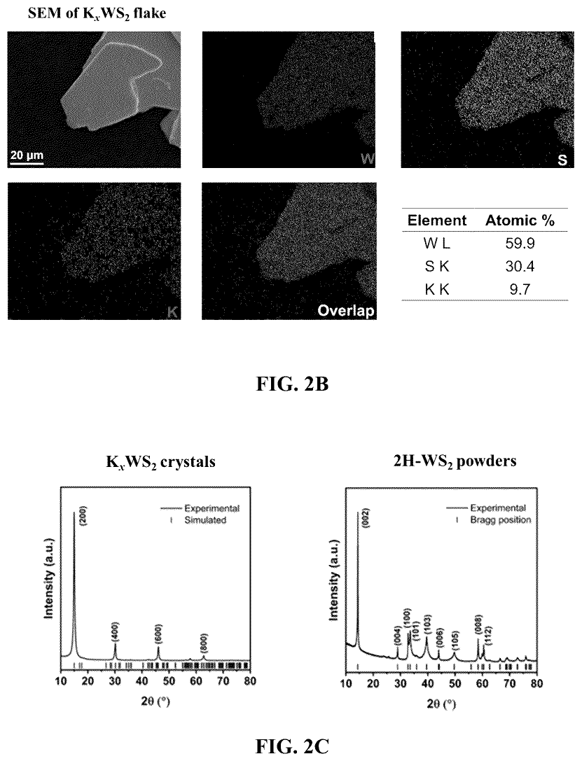

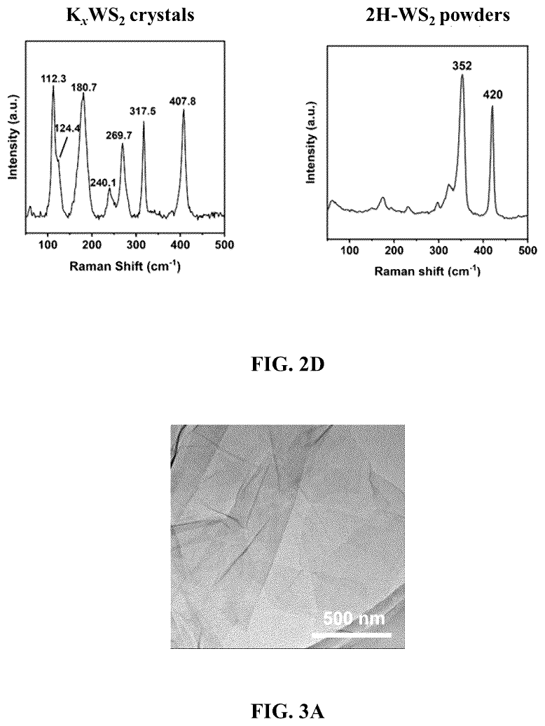

The morphology and composition of the synthesized 1T′-phase crystals were characterized to verify their structural integrity and phase purity. SEM images, as shown in FIG. 2A, reveal that the KₓWS₂ crystals possessed a plate-like morphology with lateral sizes of several hundred micrometers, exhibiting a brighter appearance compared to the rougher surface of conventional 2H-phase powders. EDS data indicates that these crystals contain an intercalated potassium content, for instance, approximately 5% to 15% atomic potassium (e.g., 9.7%), which facilitates the stabilization of the semimetallic phase (FIG. 2B).

XRD patterns and Raman spectra further confirm the phase transformation. As shown in FIG. 2C, the XRD peaks of the obtained crystals are consistent with the simulated 1T′-WS₂, showing clear shifts relative to the 2H phase. Raman spectra exhibits characteristic 1T′ vibrational modes, specifically at peaks located at approximately 112, 181, 240, 270, 317, and 408 cm⁻¹, while the absence of 2H-specific peaks at 352 and 420 cm⁻¹ confirms high phase purity (FIG. 2D).

The chemical exfoliation efficiency of the 1T′-phase crystals demonstrates a significant technical advantage over the 2H phase. Upon sonication in an acidic medium, the 1T′-phase materials form a high-concentration, stable black dispersion, achieving an unexpectedly high exfoliation yield of at least 80% (e.g., approximately 90.8%), which represents a more than 100-fold increase compared to the yield of the 2H-phase counterparts (e.g., approximately 0.83%) (Table 1). This remarkable efficiency is attributed to the intercalated cations (e.g., K⁺) which expand the interlayer spacing to facilitate solvent penetration and delamination. The process is readily scalable, enabling the production of 1T′-TMD dispersions at concentrations up to 10 g L⁻¹ in large volumes.

TABLE 1
Inductively coupled plasma-mass spectrometry (ICP-MS) results of the
corresponding WS₂ concentration in the as-exfoliated samples

| | Concentration | Exfoliation Efficiency |
|---|---|---|
| | (mg L⁻¹) | (%) |
| 1T′-WS₂ after sonication | 2424.7 | 90.8% |
| 2H-WS₂ after sonication | 22.3 | 0.83% |

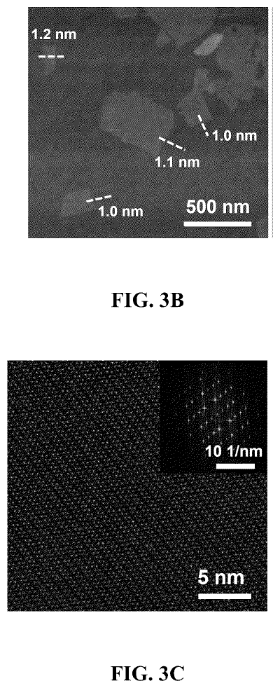

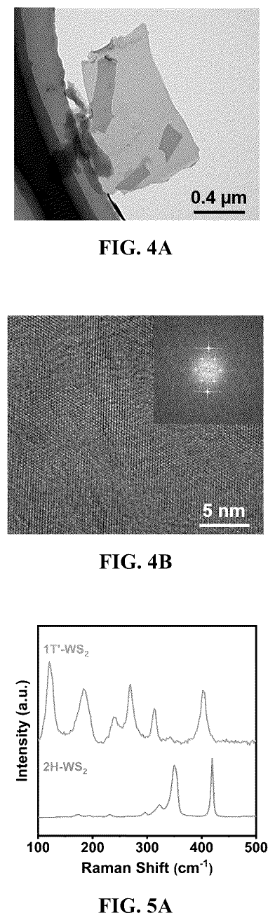

As shown in the TEM, the derived 1T′-WS₂ NSs possess a silky, ultrathin sheet morphology with lateral sizes up to several micrometers (FIG. 3A). The AFM images indicate that the 1T′-WS₂ NSs have an average thickness of 1.1±0.2 nm (FIG. 3B), while the 2H-WS₂ NSs exhibit a thickness of 1.9±0.4 nm. Aberration-corrected HAADF-STEM image reveals the zigzag chain arrangement, while the corresponding SAED pattern displays distinct diffraction spots characteristic of the 1T′ phase (FIG. 3C), in sharp contrast to the hexagonal diffraction pattern of 2H-WS₂ (FIGS. 4A-4B).

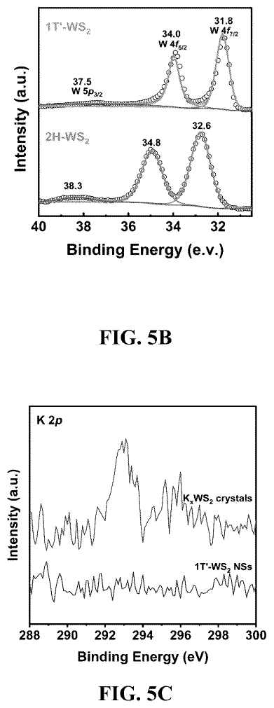

Raman spectroscopy further confirmed the phase purity of 1T′-WS₂ NSs (FIG. 5A). Five distinctive Raman peaks located at 130, 205, 256, 310, and 408 cm⁻¹, are observed, confirming the 1T′ phase crystal structure, which is quite different from the 2H counterparts. This observation further indicates the high phase purity of the synthesized nanosheets.

The electronic and optical properties of the 1T′-TMD NSs are further distinguished from the 2H phase via spectroscopy. As shown in FIG. 5B, XPS data revealed a ~0.8 eV shift in the W 4f_{5/2} and W 4f_{7/2} binding energies relative to the 2H phase, consistent with the semimetallic nature of the 1T′ structure, and no potassium residues were detected in the exfoliated NSs (FIG. 5C).

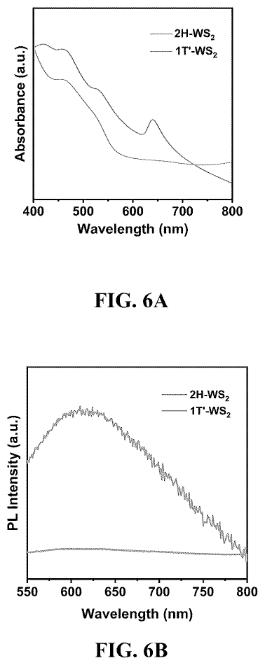

Optical absorption further distinguished the two phases: 2H-WS₂ exhibited distinct excitonic resonances in the visible region, whereas 1T′-WS₂ showed a featureless broadband response (FIG. 6A), indicative of delocalized electronic states. Photoluminescence spectroscopy (FIG. 6B) revealed strong emission from the semiconducting 2H phase but no detectable signal from 1T′-WS₂, confirming the suppression of radiative recombination and the predominance of nonradiative energy dissipation in the semimetallic phase.

### Example 3—Ultrafast Carrier Dynamics and Photothermal Mechanisms

To elucidate the superior photothermal conversion mechanism of the semimetallic 1T′ phase, Femtosecond transient absorption spectroscopy (fs-TAS) was performed to resolve the carrier relaxation dynamics. samples of 1T′-WS₂ and 2H-WS₂ were excited by a pump pulse (e.g., centered at 380 nm) and probed by pulses spanning a broad range (e.g., 460-997 nm) to collect difference spectra (ΔA(λ)), which is defined as: ΔA(λ)=A(λ)−A₀ (λ), where A(λ) and A₀ (λ) denote the pumped and unpumped absorption, respectively.

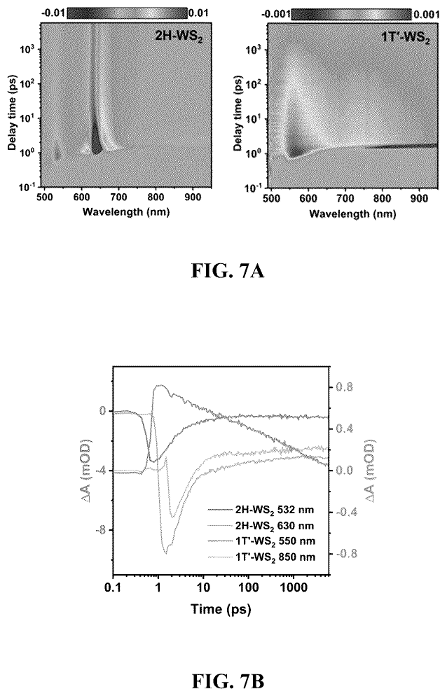

The transient spectra of 2H-WS₂, as illustrated in FIGS. 7A-7B, reveal complex excitonic responses. A strong negative AA feature at ~630 nm corresponds to ground-state bleaching (GSB) of the A exciton, persisting for more than a nanosecond, while a secondary bleaching peak at ~532 nm arises from the B exciton. Both originate from state-filling effects induced by photoexcited carriers. Two excited-state absorption (ESA) features also emerge: one at 610-630 nm, attributed to transitions from intermediate states, and another at 650-670 nm, arising from hot-carrier absorption into higher conduction-band levels. In contrast, 1T′-WS₂ (FIGS. 7A-7B) displays a dominant ESA band at 550 nm that persists beyond one nanosecond, reflecting a high density of intermediate states characteristic of its delocalized electronic structure. This sustained ESA response indicates prolonged thermalization and effective nonradiative dissipation. At longer probe wavelengths (750-950 nm), the signal comprises both negative and positive contributions: the negative component arises from bleaching of the localized surface plasmon resonance (LSPR), while the coexisting positive feature reflects excited-state absorption associated with hot-carrier redistribution. The semimetallic nature of the 1T′ phase facilitates a strong plasmonic response driven by collective free-carrier oscillations. This mechanism enables ultrafast nonradiative relaxation, which generates significantly more intense thermal effects compared to the conventional excitonic recombination pathways typically found in semiconducting phases. By prioritizing these rapid nonradiative decay channels, the 1T′-TMDs effectively convert absorbed solar energy into localized heat with higher efficiency and speed.

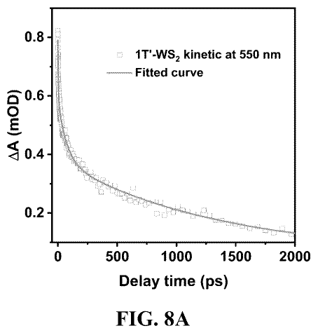

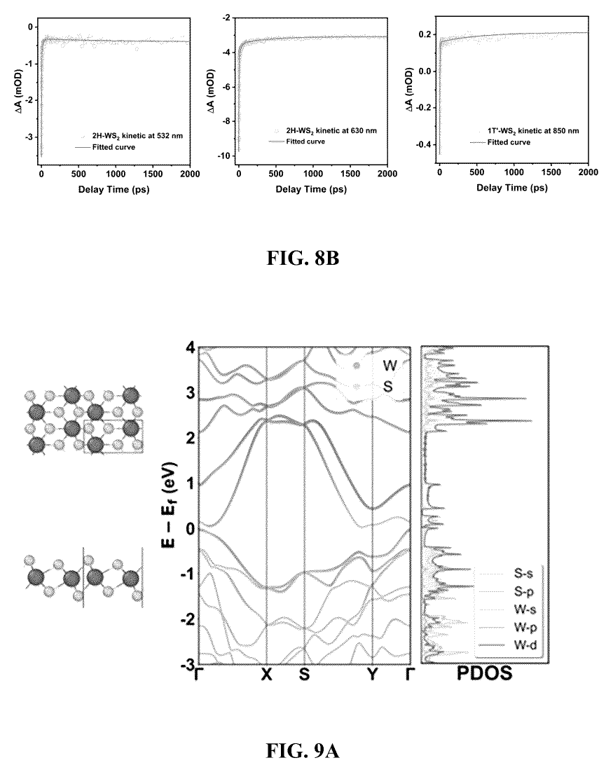

To further quantify the carrier relaxation behavior, multiexponential fitting of transient absorption kinetics was conducted, as shown in FIGS. 8A-8B and Table 2). For 2H-WS₂, the transient signals at both 532 and 630 nm are dominated by ultrafast decays, with lifetimes of 1.48 ps (77.9%) and 2.27 ps (81.8%), respectively, indicative of rapid carrier trapping and nonradiative recombination. In addition to these major components, minor longer-lived contributions are observed: τ₂=14.98 ps and τ₃=1070.9 ps at 532 nm, and τ₂=30.8 ps and τ₃=406.1 ps at 630 nm. In sharp contrast, the carrier dynamics of 1T′-WS₂ reveal a dual relaxation pathway. At 550 nm, the transient response is characterized by three successive rise components with lifetimes of 3.82 ps (27.3%), 72.3 ps (28.8%), and 1331.1 ps (43.9%). This progressive increase reflects the stepwise population of intermediate conduction-band states and sustained excited-state absorption, indicative of efficient carrier accumulation and long-lived nonradiative dissipation. At 850 nm, the transient absorption dynamics are dominated by a fast negative component with a lifetime of ~4.5 ps, accounting for nearly 68% of the signal, indicative of rapid recovery of the photoinduced bleaching through hot-carrier cooling. A secondary positive contribution emerges at ~1.4 ps (24%), which can be ascribed to excited-state absorption and intraband scattering processes. In addition, a long-lived positive background persists with a characteristic lifetime of ~0.56 ns (8%), reflecting lattice heating and thermal diffusion. Collectively, these results demonstrate that photoexcited carriers in 1T′-WS₂ rapidly dissipate their energy into the lattice on the picosecond timescale, thereby enabling efficient nonradiative relaxation and underpinning its strong photothermal conversion capability.

TABLE 2
Fitting results of 2H-WS₂ (532 nm and 630 nm) and 1T′-WS₂
(550 nm and 850 nm) for the TAS experiment with 380 nm excitation

| | 2H-WS₂@532 | 2H-WS₂@630 | 1T′-WS₂@550 | 1T′-WS₂@850 |
|---|---|---|---|---|
| | nm | nm | nm | nm |
| τ₁ | 1.48 ± 0.06 | 2.27 ± 0.05 | 3.82 ± 0.32 | 4.49 ± 0.14 |
| | (77.9%, −) | (81.8%, −) | (27.3%, +) | (67.9%, −) |
| τ₂ | 14.98 ± 1.81 | 30.8 ± 4.1 | 72.3 ± 5.7 | 1.36 ± 0.22 |
| | (19.8%, −) | (12.2%, −) | (28.8%, +) | (24.0%, +) |
| τ₃ | 1070.9 ± 738.5 | 406.1 ± 72.6 | 1331.1 ± 71.3 | 557.5 ± 96.9 |
| | (2.3%, +) | (6.0%, −) | (43.9%, +) | (8.1%, +) |

### Example 4—First-Principles Electronic and Optical Characterization

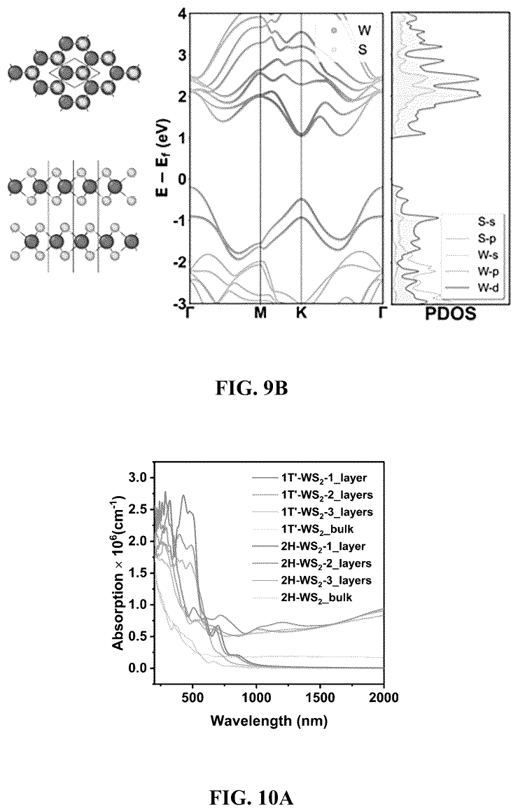

To further elucidate the intrinsic photothermal potential of the semimetallic phase, first-principles calculations were conducted to compare the electronic and optical properties of 1T′-WS₂ and 2H-WS₂ using unit cell models. As illustrated in the band structures and projected density of states (PDOS) calculations (referring to FIGS. 9A-9B), a distinct contrast is observed between the two phases. The 2H phase exhibits a well-defined bandgap and sharp band-edge states, which is consistent with the pronounced excitonic resonances observed in experimental spectroscopy.

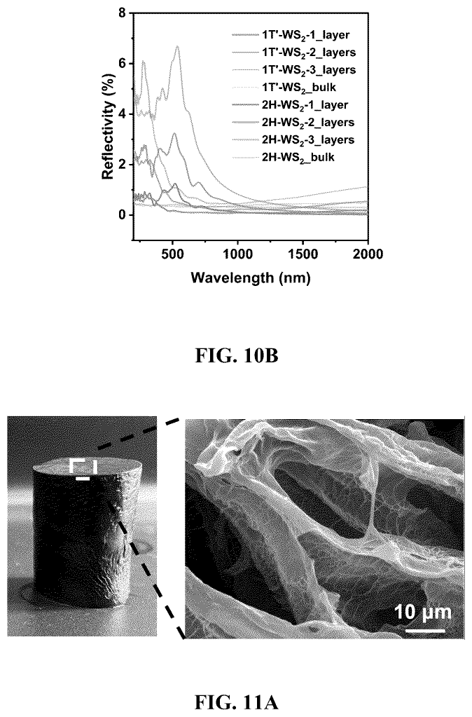

In contrast, the 1T′-WS₂ displays semimetallic features with delocalized states and a continuous density of states across the Fermi level. This electronic configuration is in direct agreement with the exciton-free, broadband transient response of the material. The simulated optical spectra (FIG. 10A) show that while the 2H phase exhibits strong absorption primarily near the ultraviolet band edge, the 1T′ phase sustains superior broadband absorption spanning from the visible to the infrared regions, reflecting its metallic-like character. This behavior is further corroborated by the corresponding reflectance spectra. (FIG. 10B).

Thickness-dependent calculations further reveal that few-layer structures, such as monolayer to trilayer 1T′-WS₂ nanosheets, display significantly stronger absorption compared to the bulk material. These combined theoretical insights demonstrate that the intrinsic electronic structure of 1T′-WS₂ provides a fundamental advantage for high-efficiency solar energy harvesting and photothermal conversion across a broad spectral range.

### Example 5—Hydrogel Characterization

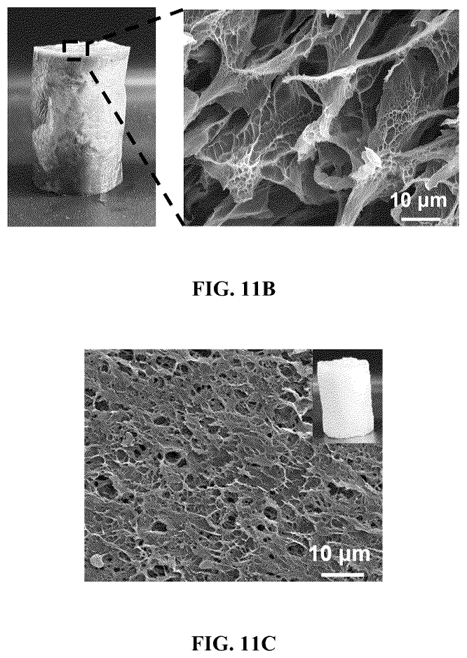

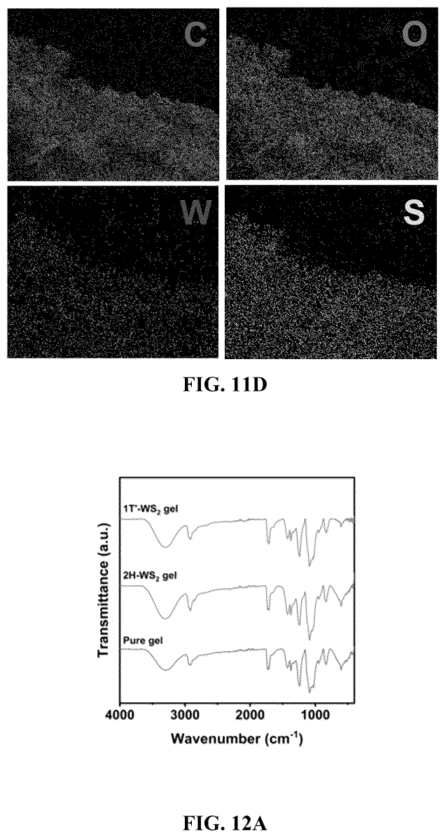

The structural and morphological characteristics of the 1T′-phase TMD hydrogels were evaluated to determine their suitability for solar-driven evaporation. As illustrated in the optical and SEM imaging in FIG. 11A, the 1T′-WS₂ gel exhibits a black appearance and a highly porous architecture. This interconnected network not only facilitates rapid capillary water transport but also extends optical pathways through multiple reflections and reabsorption within the gel matrix. By contrast, the 2H-WS₂ gel appears dark green with less interconnected porosity (FIG. 11B), while the pure PVA gel is white with a rough surface and shallow pores (FIG. 11C). Elemental mapping (FIG. 11D) reveals a uniform distribution of W and S throughout the 1T′-WS₂ gel. This uniform dispersion effectively confines solar-generated heat within the molecular framework, limiting thermal loss to the bulk water and enhancing interfacial heating efficiency.

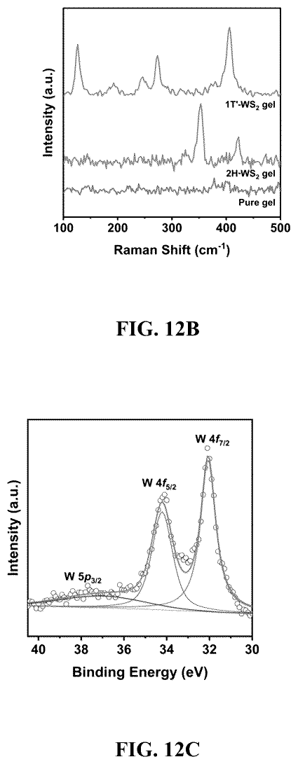

The FTIR analysis (FIG. 12A) further validates the incorporation of WS₂ NSs into the PVA matrix, while Raman and XPS characterizations (FIGS. 12B-12C) confirm that the 1T′ phase retains its structural integrity after embedding within the hydrogel.

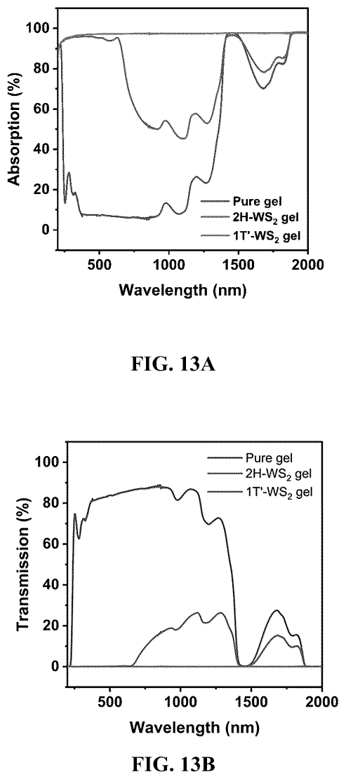

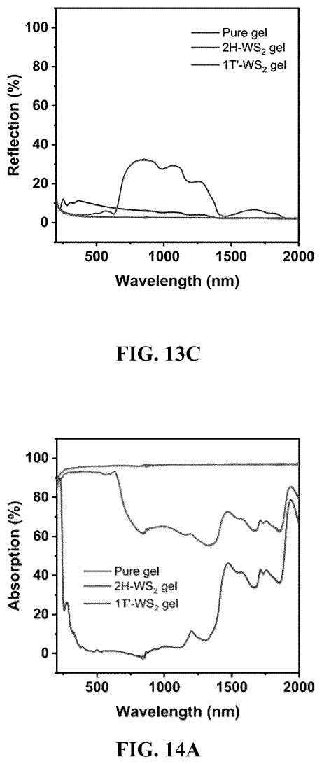

It is worth noting that efficient solar thermal evaporation critically relies on the effective capture of a broad solar spectrum. The solar absorption properties of the gels were evaluated using Ultraviolet-Visible-Near Infrared (UV-Vis-NIR) spectroscopy. As shown in FIG. 13A, the hydrated 1T′-WS₂ gel exhibited exceptional absorption across a wide wavelength range (200-2000 nm), with much lower reflectance and transmittance compared to the other gels (FIGS. 13B-13C). Solar absorptance (a), defined as the ratio of absorbed to incident solar radiation energy, provides a more representative metric for photothermal performance than average absorption, given the nonuniform distribution of the solar spectrum. The a value was calculated from the measured reflectance and transmittance spectra according to the following equation (1):

$$α = \frac{{\int }_{200}^{2000} I ( λ ) ( 1 - R ( λ ) - T ( λ ) ) d λ}{{\int }_{200}^{2000} I ( λ ) d λ} , \qquad ( 1 )$$

where I(λ), R(λ), and T(λ) represent the wavelength-dependent AM1.5G solar spectral irradiance, reflectance, and transmittance, respectively.

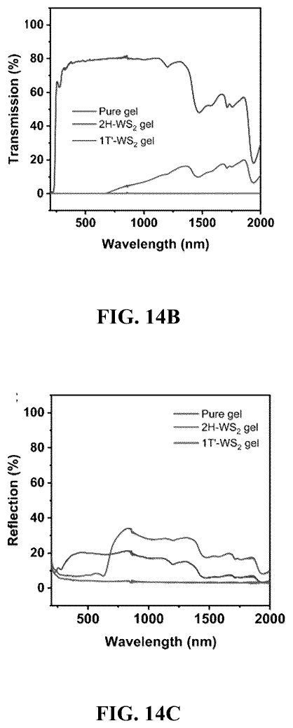

The calculated a values for all samples over the 200-2000 nm range are summarized in Table 3. The hydrated 1T′-WS₂ gel exhibits a solar absorptance of ~0.98, substantially higher than that of the hydrated 2H-WS₂ gel (~0.76) and the pure gel (~0.14). Similar trends are observed in the dry state, with absorptances of ~0.97 (1T′-WS₂), ~0.78 (2H-WS₂), and ~0.04 (pure gel) (FIGS. 14A-14C). These results highlight the markedly superior solar energy harvesting capability of the 1T′-WS₂ gel relative to the 2H phase and pure gel, establishing its strong potential for efficient solar-driven water evaporation.

TABLE 3

| UV-Vis-NIR absorptivity of pure gel, 2H-WS₂ gel, and 1T′-WS₂ gel under | |
|---|---|
| wet and dry state | |
| Samples | Absorptance |
| Wet pure gel | 0.14 |
| Wet 2H-WS₂ gel | 0.76 |
| Wet 1T′-WS₂ gel | 0.98 |
| Dry pure gel | 0.04 |
| Dry 2H-WS₂ gel | 0.78 |
| Dry 1T′-WS₂ gel | 0.97 |

### Example 6—Performance Evaluation and Desalination Testing

To evaluate the solar-driven water evaporation performance of the 1T′-TMD hydrogels such as 1T′-WS₂ gel, experiments were conducted under controlled ambient conditions at a temperature of 20±2° C. and a relative humidity of 65±5%. The sunlight was provided by a Xenon-lamp (Zolix, China) coupled with an AM1.5G optical filter. The size of the light spot was controlled via an aperture, avoiding exposure to areas other than evaporator. Before taking any measurements, the lamp was warmed up more than 30 minutes where stability was attained. The solar flux was adjusted by changing the current and calibrated using an optical power meter (Newport, 91150V) to ensure that the actual light intensity is 1 kWm⁻².

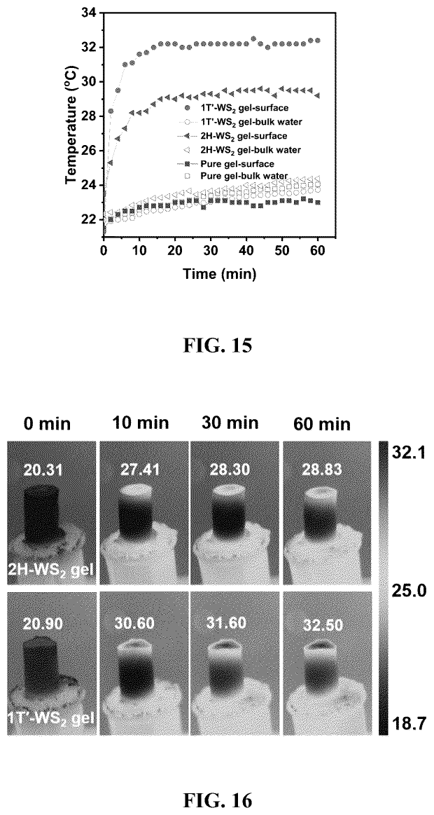

The hydrogel was placed on polystyrene (PS) foam covered with air-laid paper for thermal insulation and water transportation. Upon exposure to 1 sun irradiation, the surface temperature of each gel and the underlying bulk water were monitored over time to assess their photothermal behavior (FIG. 15). Both the 1T′- and 2H-WS₂ gel exhibited a rapid increase in surface temperature within 10 minutes. The 1T′-WS₂ gel reached a steady-state temperature of approximately 32.5° C., whereas the 2H-WS₂ gel stabilized at around 28.8° C. Notably, the bulk water temperature beneath the 1T′-WS₂ gel remained stable at 22-23° C., indicating effective thermal confinement within the evaporation layer.

Infrared thermal images captured at 0, 10, 30, and 60 min (FIG. 16) further confirmed the higher surface temperature of the 1T′-WS₂ gel compared to the 2H-WS₂ gel and pure gel, with thermal energy predominantly retained at the evaporation interface rather than dissipated into the bulk water.

Additionally, the side temperature of the gel remained lower than the ambient environment, suggesting that heat flowed into the system from the surroundings through lateral heat exchange. Thus, during the water evaporation process, the energy input originated from both direct solar irradiation at the gel surface and environmental heat absorbed through the sides of the three-dimensional gel structure.

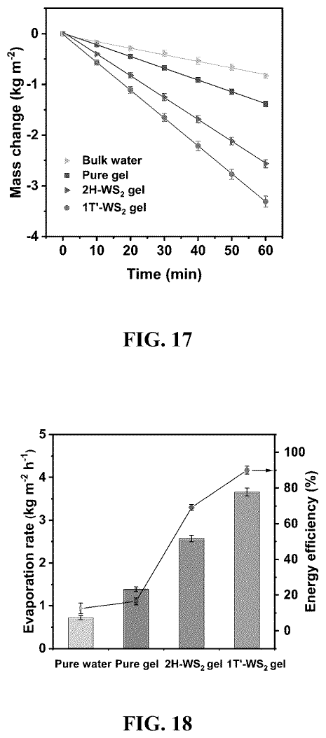

The water evaporation performance of the three solar evaporators under 1 sun illumination was evaluated by tracking the time-dependent mass loss of water over time (FIG. 17). The 1T′-WS₂ gel (0.26 wt %) exhibited the highest evaporation rate, reaching approximately 3.6 kg m⁻² h⁻¹, substantially outperforming the 2H-WS₂ gel (~2.6 kg m⁻² h⁻¹) and the pure PVA gel (~1.4 kg m⁻² h⁻¹). Thermal losses due to reflection, convection, radiation, and conduction were systematically quantified for each hydrogel (Table 4). The 1T′-WS₂ gel demonstrated the lower cumulative thermal losses, particularly minimizing reflective (0.009 W·h) and conductive (0.001 W·h) losses compared to the 2H-WS₂ gel.

TABLE 4
Parameters for solar steam generation performance calculation

| | R | Qₛₒₗ | | H | Aₗₐₜ | Tₗₐₜ | A_{surf} | T_{surf} | Tₑₙᵥ | m_{bulk} | Tᵢₙᵢ | T_{end} |
|---|---|---|---|---|---|---|---|---|---|---|---|---|
| | (cm) | (wh) | A | (cm) | (cm²) | (K) | (cm²) | (K) | (K) | (g) | (K) | (K) |
| Pure gel | 1.2 | 0.45 | 0.17 | 3 | 2.3 | 290.5 | 4.5 | 294.68 | 295.55 | 15 | 295.13 | 295.14 |
| 2H-WS₂ | 1.2 | 0.45 | 0.75 | 3 | 2.3 | 294.42 | 4.5 | 301.98 | 298.05 | 15 | 295.13 | 295.19 |
| gel | | | | | | | | | | | | |
| 1T'-WS₂ | 1.2 | 0.45 | 0.98 | 3 | 2.3 | 296.45 | 4.5 | 305.15 | 299.15 | 15 | 295.13 | 295.20 |
| gel | | | | | | | | | | | | |

Abbreviations:
R is the radius of the evaporator, Qₛₒₗ is the total solar input, A is the optical absorptivity, H is the height of the evaporator, Aₗₐₜ and Tₗₐₜ are the lateral surface area and temperature, respectively, A_{surf}_and T_{surf} are the top surface area and temperature, Tₑₙᵥ is the ambient temperature, m_{bulk} is the bulk water mass, Tᵢₙᵢ and T_{end} are the initial and final temperatures of bulk water

Thermal conductivity measurements further revealed that the 1T′-WS₂ gel exhibited a thermal conductivity of 0.539 W m⁻¹ K⁻¹, comparable to the pure PVA gel (0.536 W m⁻¹ K⁻¹) but lower than the 2H-WS₂ gel (0.605 W m⁻¹ K⁻¹), thus contributing to suppressed heat dissipation into the underlying bulk water.

The solar-to-vapor efficiency n of the hydrogel evaporator was determined by considering the input solar energy and the major thermal loss channels:

$$η = 1 - \frac{{Q}_{loss}}{{Q}_{solar}} , \qquad ( 2 )$$

the total solar energy (Qₛₒₗₐᵣ) is calculated as:

Qₛₒₗₐᵣ=CₒₚₜP₀Aₜₒₚt, (3)

where Cₒₚₜ is the optical concentration factor of the solar simulator, P₀ is the nominal direct solar irradiation (1 kW m⁻²), and Aₜₒₚ is the top surface area of the evaporator, and t is the irradiation duration time.

The total loss (Qₗₒₛₛ) mainly originates from: (1) conduction heat loss from the evaporator to water, (2) radiation and (3) convection heat losses from the evaporator to environment, which can be described by the following formula: Qₗₒₛₛ=Q_{reflection}+Q_{radiation}+Q_{convection}+Q_{conduction}. The solar energy loss by reflection (Q_{reflection}) is estimated as below: Q_{reflection}=RQₛₒₗₐᵣ, where R is the solar reflectivity of the evaporator.

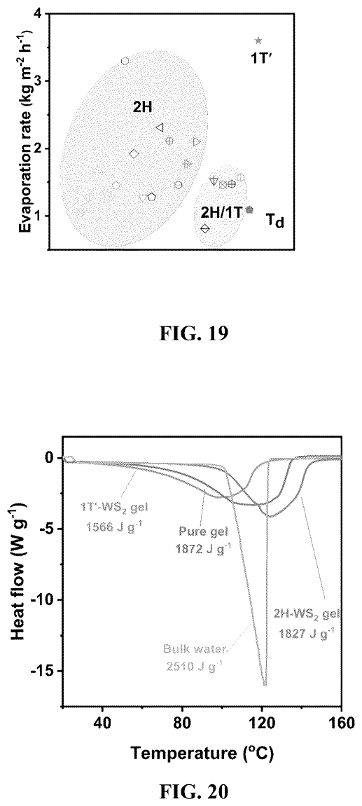

The solar-to-vapor conversion efficiency (n) were determined to be 16.5%, 68.0%, and 90.0% for the pure gel, 2H-WS₂, and 1T′-WS₂ gel, respectively (FIG. 18). The much higher efficiency of the 1T′-WS₂ gel highlights its superior ability to convert solar energy into vapor, attributed to its abundant solar absorption and highly efficient photothermal conversion. Notably, the 1T′-WS₂ gel exhibits a water evaporation rate surpassing those of previously reported TMD-based evaporators across various phase structures (FIG. 19).

To elucidate the mechanistic origin of the enhanced evaporation performance, differential scanning calorimetry (DSC) was first employed to determine the vaporization enthalpy of bulk water and the hydrogel systems.

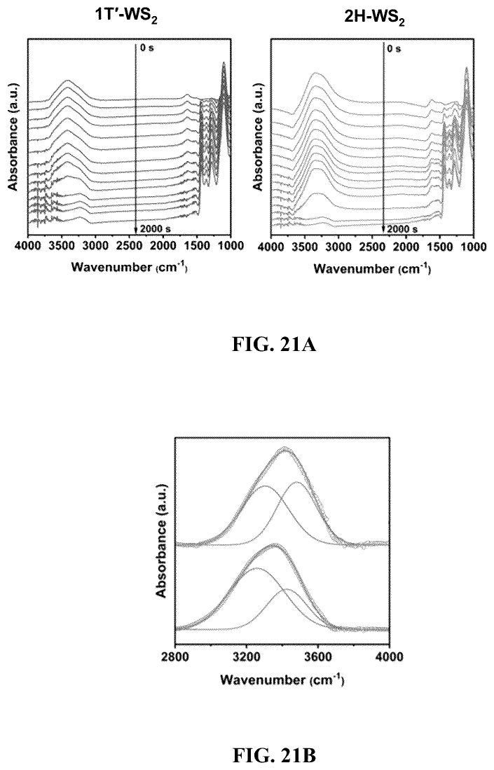

Bulk water exhibited a sharp endothermic peak with rapid decay (FIG. 20), yielding a vaporization enthalpy of 2501 J g⁻¹, in close agreement with the theoretical value of 2450 J g⁻¹. In contrast, all hydrogels displayed broadened peaks with gradual attenuation, signifying evaporation dynamics that differ fundamentally from those of pure water. Among them, the 1T′-WS₂ gel demonstrated the lowest vaporization enthalpy (1566 J g⁻¹), reflecting a markedly reduced energetic demand for vapor generation. FTIR analysis disclosed distinct phase-dependent differences in water bonding environments. Relative to the 2H phase, the spectra of the 1T′ phase exhibited a pronounced blueshift together with an increased contribution of weakly hydrogen-bonded species, reflecting reduced hydrogen-bonding strength and lower energy barriers for desorption (FIGS. 21A-21B).

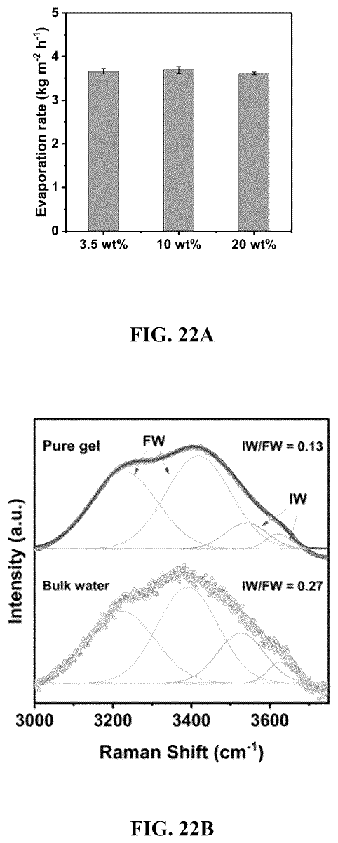

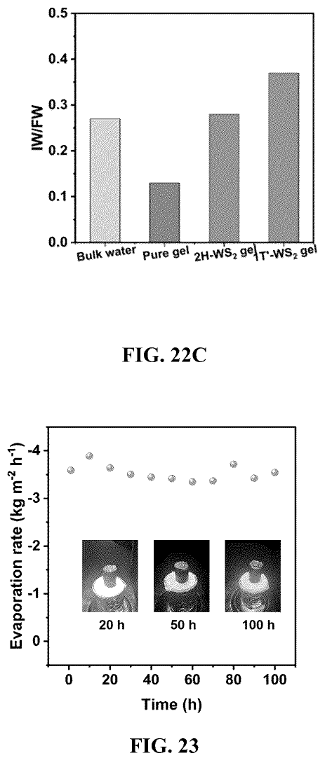

Furthermore, Raman spectra of interfacial water on the three hydrogels and bulk water were recorded (FIGS. 22A-22C). Gaussian function fitting identified four characteristic peaks: 3233 and 3401 cm⁻¹, corresponding to the in-phase and out-of-phase vibrational modes of fully hydrogen-bonded free water molecules with four hydrogen bonds; and 3514 and 3630 cm⁻¹, corresponding to the symmetric and asymmetric stretching vibrations of intermediate water molecules with fewer hydrogen bonds.

Deconvolution of the Raman O—H stretching band (3000-3650 cm⁻¹) yields four characteristic peaks assigned to different hydrogen-bonding states: 3233 and 3401 cm⁻¹ correspond to fully hydrogen-bonded free water (FW), while 3514 and 3630 cm⁻¹ correspond to intermediate water (IW) with fewer hydrogen bonds. The relative contributions of each peak were used to calculate the overall FW and IW fractions, as well as the IW/FW molar ratio. The 1T′-WS₂ gel exhibits the highest IW fraction and largest IW/FW ratio, highlighting its enhanced population of weakly bonded water species. As summarized in Table 5, the 1T′-WS₂ gel exhibits the highest fraction of intermediate water (~26.8%) and the largest IW/FW ratio (0.37:1), surpassing bulk water (21.2%, 0.27:1), the 2H gel (22.0%, 0.28:1), and the pure PVA gel (11.6%, 0.13:1). Given that intermediate water exhibits a significantly faster evaporation rate than fully hydrogen-bonded water, this enrichment provides a molecular explanation for the lower vaporization enthalpy observed in DSC. Taken together, DSC, FTIR, and Raman analyses establish a coherent mechanism in which the semimetallic 1T′ phase weakens hydrogen-bond interactions, enriches intermediate water species, and consequently reduces the vaporization enthalpy. This phase-dependent regulation of interfacial water states provides the molecular basis for the superior solar-driven evaporation performance of 1T′-WS₂ hydrogels.

TABLE 5
Raman peak deconvolution of interfacial water

| | 3233 | 3401 | 3514 | 3630 | | | IW/ |
|---|---|---|---|---|---|---|---|
| | cm⁻¹ | cm⁻¹ | cm⁻¹ | cm⁻¹ | FW | IW | FW |
| Bulk | 35.5% | 43.3% | 17.4% | 3.82% | 78.8% | 21.2% | 0.27:1 |
| water | | | | | | | |
| Pure gel | 40.6% | 47.8% | 8.62% | 2.90% | 88.4% | 11.6% | 0.13:1 |
| 2H-WS₂ | 38.4% | 39.6% | 15.5% | 6.51% | 78.0% | 22.0% | 0.28:1 |
| gel | | | | | | | |
| 1T′-WS₂ | 41.7% | 31.5% | 22.7% | 4.14% | 73.2% | 26.8% | 0.37:1 |
| gel | | | | | | | |

For seawater desalination experiments, sodium chloride was directly dissolved in deionized water to form different simulated seawater (3.5, 10, and 20 wt %). A real seawater sample collected from the Xi Gong Sea was also used for solar desalination experiments. Thermal images were captured by an infrared camera (TiS75+, Fluke). The real-time temperature distributions and bulk water temperature were measured using thermocouples and recorded by data acquisition. The mass loss during vapor generation was recorded every 10 min in real-time using an electronic balance (Radwag, WTC 200) with an accuracy of 0.001 g. The concentrations of salt ions in the distilled water were analyzed using ion chromatography (IC, Metrohm 930) and inductively coupled plasma mass spectrometry (ICP-MS, PerkinElmer Nexion 2000).

Long-term stability was assessed through a 100-hour evaporation test using 3.5% saline water under open-air conditions. Under one-sun illumination, the gel sustained an average evaporation rate of 3.47±0.27 kg m⁻² h⁻¹ (FIG. 23). After continuous 10 hours of operation, only minor salt deposition was observed, which disappeared once the light was switched off, revealing an intrinsic self-cleaning capability that enables continuous daytime evaporation and nighttime recovery.

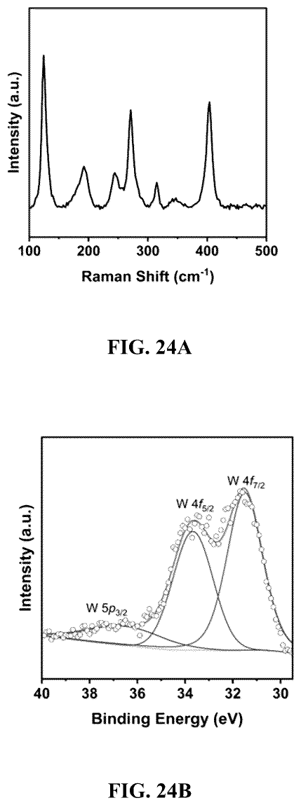

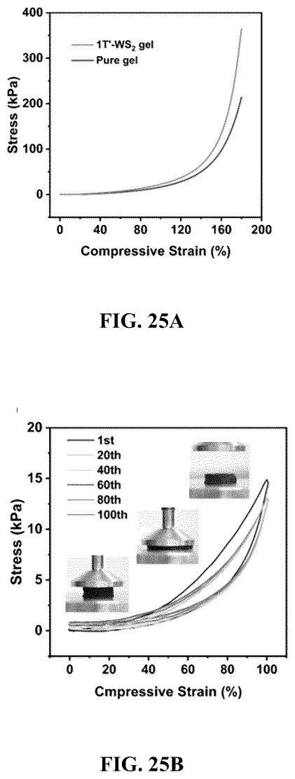

Post-test characterization by Raman and XPS (FIGS. 24A-24B) confirmed the preservation of the 1T′ phase after 100 hours, demonstrating its long-term structural stability. Beyond chemical and phase stability, the gel also exhibited remarkable mechanical robustness. It endured compressive stresses up to 350 kPa under near-complete deformation without fracture (FIGS. 25A-25B). Under cyclic compression at 50% strain, the maximum stress declined by less than 10% after 100 cycles, demonstrating excellent fatigue resistance. This mechanical robustness, combined with high water-evaporation performance, salt tolerance, and long-term phase stability, underscores the potential of the 1T′-WS₂ gel as a durable and scalable platform for practical solar desalination.

### Example 7—General Applicability Across Various 1T′-TMDs and Surface Modifications

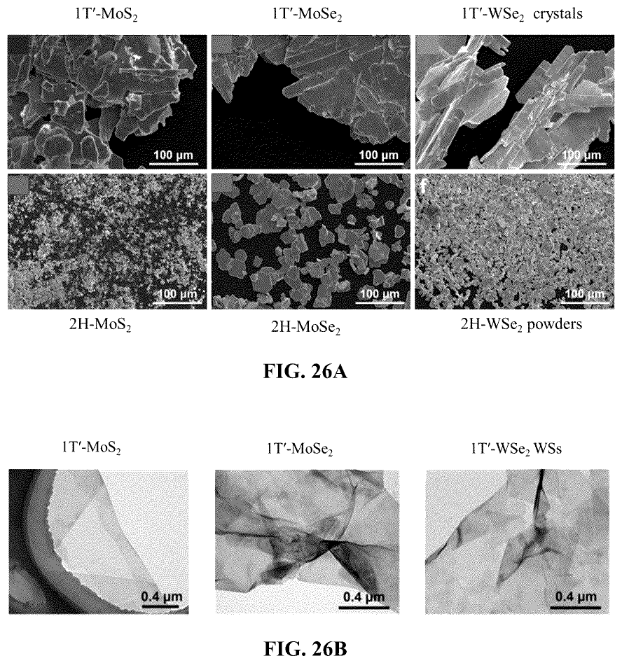

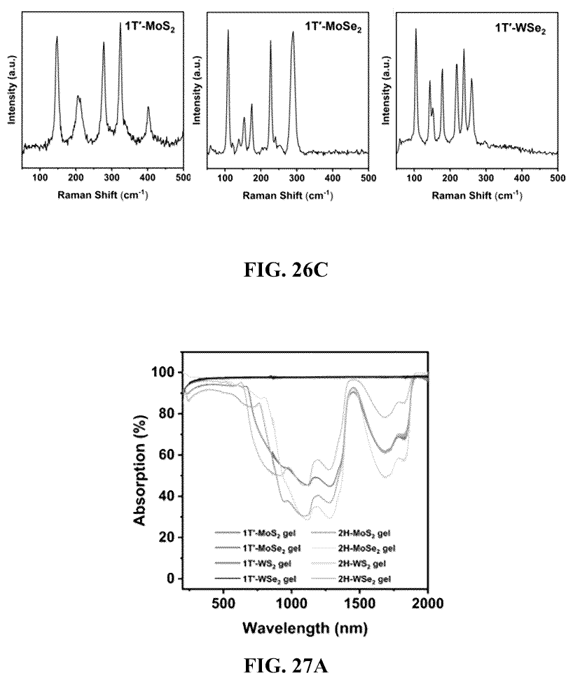

To evaluate whether the technical advantages of the phase-engineering strategy extend beyond WS₂, various 1T′-phase TMD crystals, including 1T′-MOS₂, 1T′-MoSe₂, and 1T′-WSe₂, were synthesized and exfoliated into nanosheets utilizing the salt-assisted and sonication methods previously described. Raman spectroscopy and photographic characterization confirmed high phase purity and uniform dispersion for all tested transition metal species (FIGS. 26A-26C).

The bulk g-C₃N₄ was prepared by directly heating urea without any additives. In a typical synthesis, 8 g of melamine was put in a crucible with a cover, and then it was heated at 550° C. for 2 h in a muffle furnace at a heating rate of 5° C. min⁻¹. The as synthesized bulk g-C₃N₄ were grounded into powder and put into a crucible without a cover heated to 500° C. for 5 h in a muffle furnace at a heating rate of 5° C. min₋₁ to obtain g-C₃N₄ NSs. 0.1 g g-C₃N₄ NSs was then mixed with 1 mL 1T′-WS₂ NSs suspension or 2H-WS₂ NSs under stirring. The synthesis of 1T′-WS₂/g-C₃N₄ gel and 2H-WS₂/g-C₃N₄ gel followed a similar protocol with that of 1T′-WS₂ gel, except that the 1T′-WS₂ suspension was replaced by the 1T′-WS₂/g-C₃N₄ composites and 2H-WS₂/g-C₃N₄ composites.

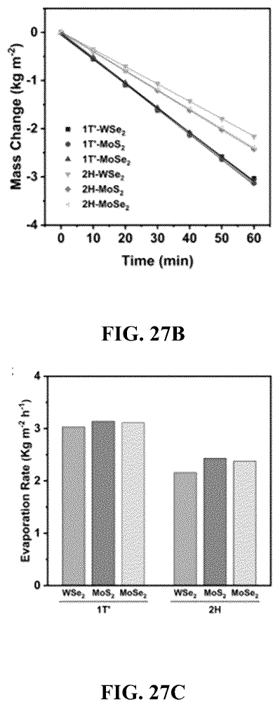

Photographic images revealed distinct coloration and uniform dispersion among the samples, while Raman, analyses confirmed their high phase purities. Using the same procedure, these NSs were incorporated into hydrogel matrices. UV-Vis-NIR spectroscopy showed that all the 1T′-based hydrogels exhibited markedly enhanced light absorption across 200-2000 nm compared with their 2H-phase counterparts (FIG. 27A). Correspondingly, photothermal evaporation tests (FIGS. 27B-27C) demonstrated consistently higher evaporation rates for the 1T′-phase hydrogels.

In another embodiment, the photothermal performance of the 1T′-TMD nanosheets is further enhanced through surface modification with noble metal nanoparticles, such as silver nanoparticles (Ag NPs). Structural analysis reveals that the Ag NPs are uniformly decorated on the surface of the 1T′-WS₂ nanosheets, exhibiting an average particle size distributed between 5 nm and 20 nm. This surface decoration induces a strong localized surface plasmon resonance (LSPR) effect, which effectively expands the broadband solar absorption and facilitates hot-carrier redistribution.

### Example 8—Outdoor Solar Evaporation Measurement

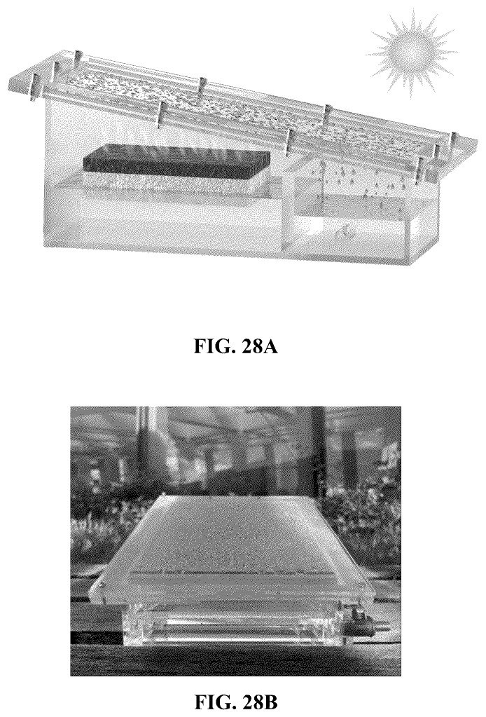

To evaluate the feasibility of continuous water production under real-world conditions, an outdoor experiment was conducted using the homemade solar evaporator device (FIGS. 28A-28B).

An outdoor steam generation experiment utilizing a piece of 1T′-WS₂ gel evaporator (dimensions: 150 mm×100 mm×10 mm) was conducted on the rooftop. A home-made double-slope made of solar still setup was used for steam condensation and water collection. Seawater sourced from Victoria Harbor was pre-filtered through a 0.22-micron membrane before being introduced into the enclosed reactor for distillation. The system harnessed natural sunlight as the energy source, with real-time solar flux and temperature being recorded hourly using a power meter (PM100D, Thorlabs Inc.) and a thermometer (Fluke), respectively. The concentrations of dye molecules in the distilled water were analyzed via UV-Vis spectrophotometry (PerkinElmer Lambda 1050+).

For the test of simultaneous water evaporation and VOCs degradation performance, simulated feedwater containing phenol was introduced into a sealed quartz reactor to conduct the distillation process under 1 sun irradiation. After 1 h of adsorption-desorption equilibrium in the dark, the degradation efficiencies of all samples were measured. The phenol concentration of the feed and collected solution was measured by high performance liquid chromatography (HPLC, Agilent) with Agilent ZORBAX Eclipse Plus C18 column (4.6×150 mm, 3 μm). The electrochemical impedance spectroscopy (EIS) measurements performed on a CHI 660E electrochemical workstation with a standard three-electrode system. Photocurrent response measurements were carried out in a standard three-electrode electrochemical cell with a working electrode, a platinum plate as counter electrode and a saturated Ag/AgCl electrode as reference electrode. A 0.2 M Na₂SO₄ aqueous solution (pH=6.8) was used as the electrolyte. Preparation of the working electrode for the photocurrent response measurement: 2 mg catalysts were dispersed in a mixed solution of 990 μL ethanol and 10 μL Nafion D-520 dispersion solutions to generate a homogeneous slurry. Subsequently, 200 μL of slurry was transferred and coated on ITO glass plates (1 cm×1 cm) then dried at room temperature.

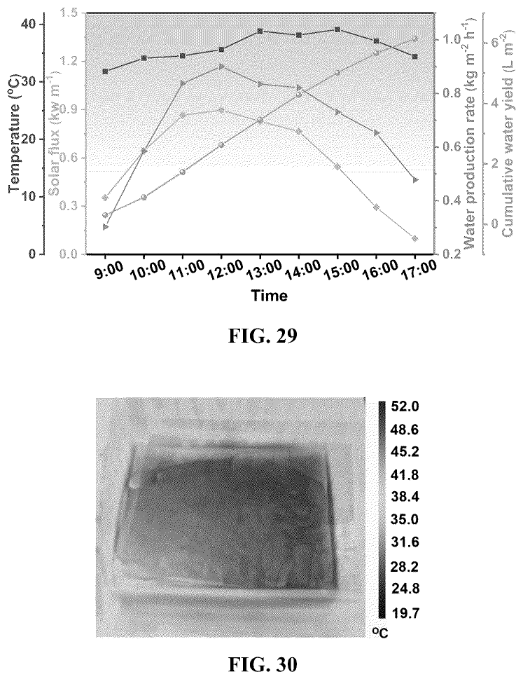

As shown in FIG. 29, the experiment was performed from 09:00 to 18:00 under natural sunlight, with an average solar heat flux of approximately 0.59 kW m⁻². The 1T′-WS₂ gel achieved an average hourly water collection rate of ~0.682 kg m⁻² h⁻¹, yielding a cumulative production of ~6.14 L m⁻² over the 9-hour period without any observable salt precipitation. Numerous droplet accumulations were observed at the top of the device and a thermal steady state was reached with a peak surface temperature of ~52° C. (FIG. 30), indicative of effective heat localization. The pronounced temperature differential between the gel surface and the ambient environment further confirmed the efficacy of localized heating, which is critical for maintaining high evaporation efficiency.

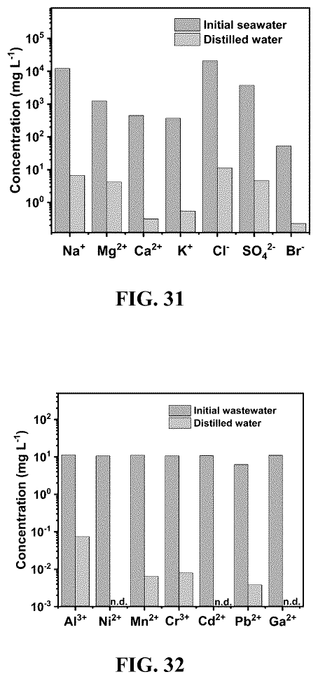

Water quality analysis demonstrated that the concentrations of major cations (Na⁺, Mg²⁺, Ca²⁺, and K⁺) and anions (Cl⁻, SO₄²⁻, and Br⁻) in the desalinated water were reduced by approximately three orders of magnitude relative to the feed water (FIG. 31). Specifically, the Na⁺ concentration in the treated water was measured at 6.63 mg L⁻¹, well below the World Health Organization (WHO) standard for potable water (200-250 mg L⁻¹), thus confirming the effectiveness of the system for the production of high-quality drinking water.

### Example 9—Multifunctional Wastewater Treatment and Decontamination

To evaluate the versatility of the phase-engineered 1T′-WS₂ hydrogel beyond seawater desalination, its performance in treating various industrial wastewater contaminants was investigated. The 1T′-WS₂ gel-based solar evaporator was employed to treat water samples contaminated with heavy metal ions and industrial dyes.

As illustrated in FIG. 32, the system achieved substantial reductions in the concentrations of multiple heavy metal ions, including Cr³⁺, Cu²⁺, Ni²⁺, Zn²⁺, and Ga³⁺. After the solar-driven purification process, the final concentrations of these ions were reduced to below 0.1 ppm, representing removal efficiencies exceeding 99.98%. These results demonstrate the high efficiency of the 1T′-WS₂ hydrogel in producing safe, potable water from heavily contaminated sources.

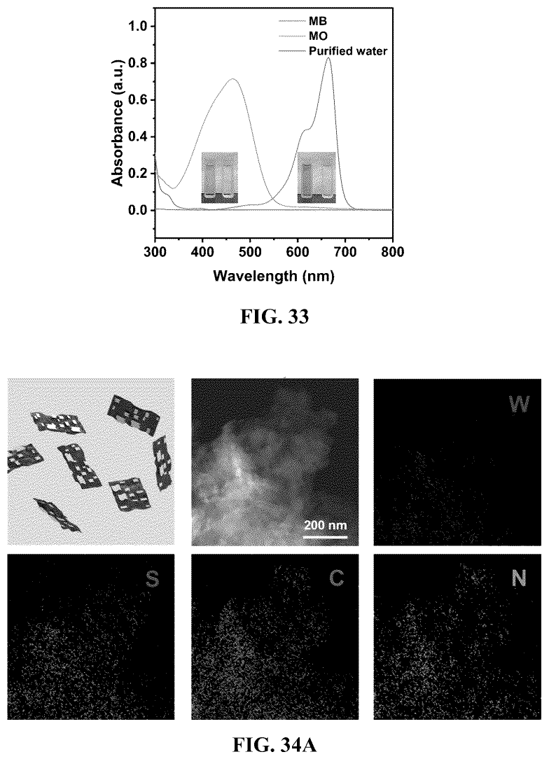

In addition to heavy metal remediation, the 1T′-WS₂ gel was tested for its ability to eliminate organic dye contaminants, specifically methyl orange and methylene blue. As confirmed by UV-Vis absorption spectroscopy and shown in FIG. 33, complete removal of these industrial dyes was achieved, yielding clear and colorless purified water.

### Example 10—Synergistic Photothermal Evaporation and Photocatalytic VOCs Degradation

To extend the functionality of the 1T′-TMD platform beyond desalination, multifunctional composite hydrogels were fabricated by coupling semimetallic 1T′-WS₂ nanosheets with graphitic carbon nitride (g-C₃N₄) via a self-assembly strategy. This hybrid system was engineered to investigate the coupled performance of solar-driven water evaporation and the photodegradation of VOCs.

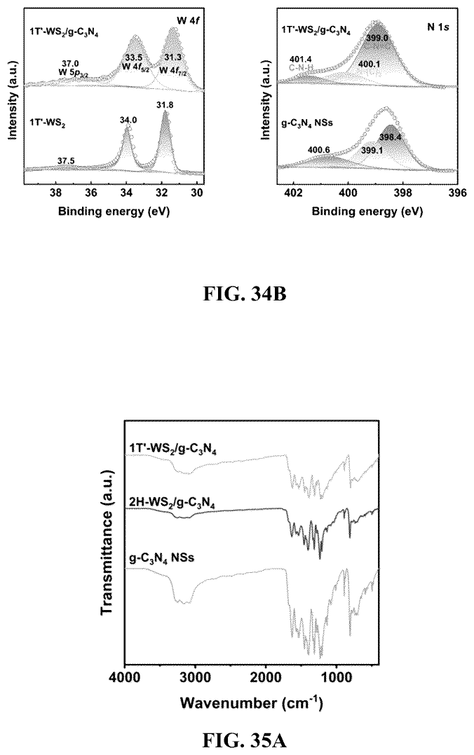

HRTEM and EDS mapping (FIG. 34A) confirmed the uniform integration of 1T′-WS₂ and g-C₃N₄, while XPS provided further insight into the interfacial electronic interactions. In the W4f spectrum of the composite (FIG. 34B), the peaks at 33.5 and 31.3 eV, assigned to W4f_{5/2} and W4f_{7/2}, were downshifted by ~0.5 eV relative to pristine 1T′-WS₂. In the N 1s spectrum, the C—N═C, N—(C)₃, and C—N—H features shifted toward higher binding energies compared with pure g-C₃N₄. These shifts indicate electron transfer from g-C₃N₄ to 1T′-WS₂, confirming the formation of a built-in electric field directed from the semiconductor to the semimetallic phase.

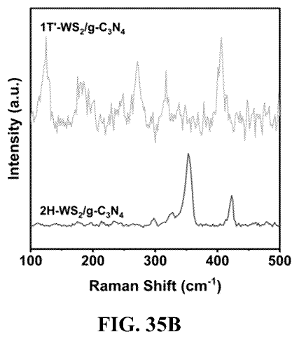

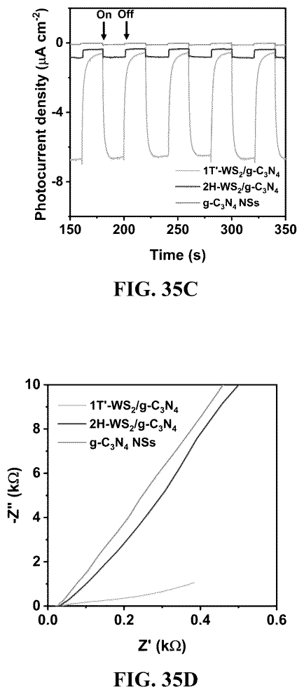

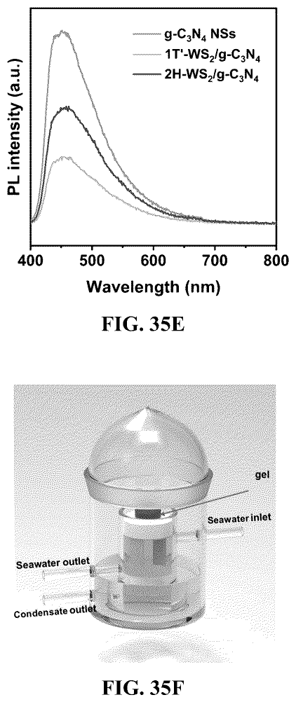

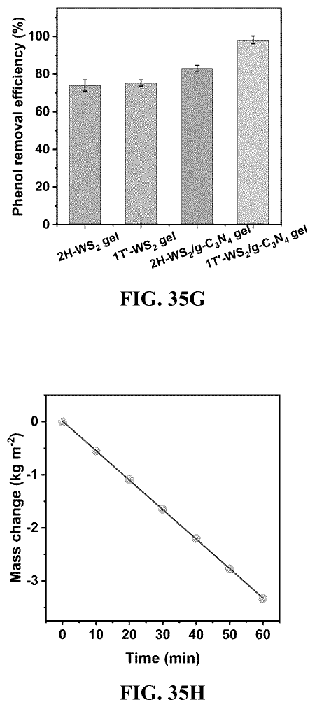

Complementary FTIR and Raman spectra (FIGS. 35A-35B) verified the successful composite formation while showing that the phase structures of both components remained intact. For comparison, 2H-WS₂/g-C₃N₄ composites were also prepared. Photoelectrochemical characterization was conducted to probe the carrier separation and transport properties of the composites. The 1T′-WS₂/g-C₃N₄ system exhibited a photocurrent density of 6.7 μA cm⁻², far exceeding that of 2H-WS₂/g-C₃N₄ (0.8 μA cm⁻²) and bare g-C₃N₄ (0.02 μA cm⁻²), suggesting substantially enhanced generation and transport of photoexcited electrons facilitated by the 1T′-WS₂ (FIG. 35C).

Furthermore, EIS measurements (FIG. 35D) revealed reduced charge-transfer resistance and enhanced carrier mobility, while photoluminescence spectra (FIG. 35E) showed markedly suppressed emission intensity, indicating efficient inhibition of electron-hole recombination. The improved charge transport is primarily attributed to the high electrical conductivity, which effectively promote rapid electron transport and suppress electron-hole recombination.

In light of the enhanced interfacial charge dynamics, the VOCs removal performance was subsequently assessed with phenol as a model contaminant in a custom-built enclosed quartz reactor (FIG. 35F). After one hour of illumination, the 1T′-WS₂/g-C₃N₄ gel exhibited a degradation efficiency of 98.1% (FIG. 35G), exceeding that of 2H-WS₂/g-C₃N₄ (~83%) gel and approaching nearly complete phenol removal. Importantly, the hybrid gel maintained a high evaporation rate of ~3.5 kg m⁻² h⁻¹ under one-sun irradiation, comparable to that of pristine 1T′-WS₂ gel (FIG. 35H), thereby demonstrating that integration with g-C₃N₄ does not compromise evaporation performance. Taken together, these results demonstrate that coupling semi-metallic 1T′-WS₂ NSs with semiconductor photocatalysts enables synergistic highly efficient photothermal evaporation and photocatalytic VOCs degradation, thereby establishing a general strategy for multifunctional solar purification systems.

### Example 11—Comparative Analysis of 1T′- and 2H-Phase TMDs Properties

To demonstrate the superior technical effects of the semimetallic 1T′ phase over the conventional semiconducting 2H phase, comprehensive comparative analyses were conducted across optical absorption, water activation, and charge carrier dynamics.

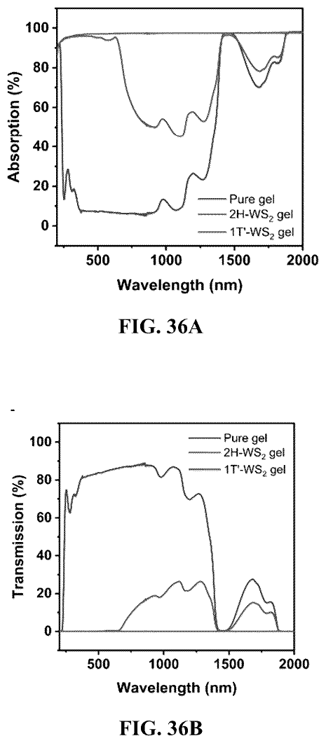

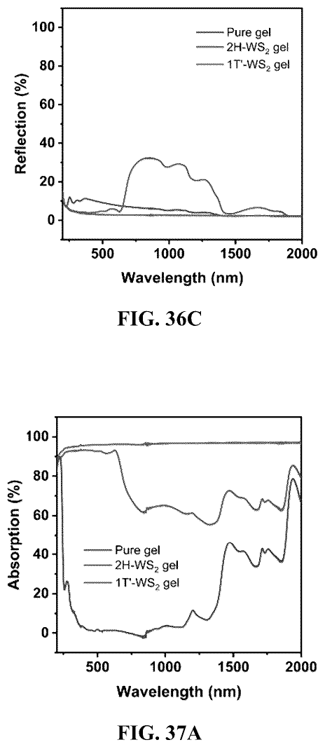

Referring to FIGS. 36A-36C, it exhibited the lowest reflectance and transmittance compared to the other gels across the entire wavelength range. The solar absorptance of the 1T′-WS₂ gel is approximately 0.98, the 2H-WS₂ gel is about 0.76, and the pure gel is only 0.14.

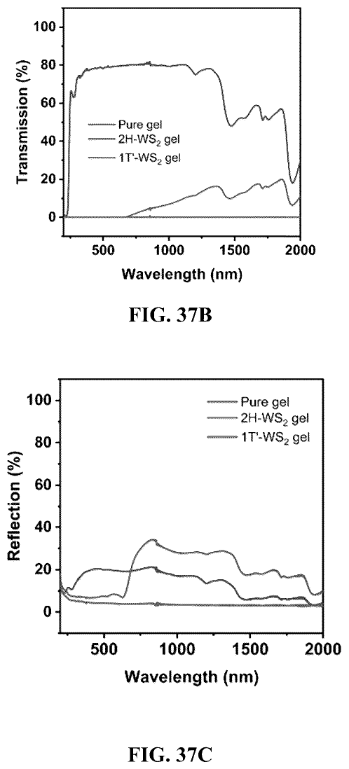

The solar absorption, transmission, and reflection spectra of the three gels in their dry state were also tested, as shown in FIGS. 37A-37C. The average solar absorptance value for the dry 1T′-WS₂ gel is around 0.97, the dry 2H-WS₂ gel is about 0.78, and the dry pure gel is only 0.04.

Furthermore, the invention demonstrates versatility in applications by enabling the integration of 1T′-TMDs with semiconductor catalysts, such as g-C₃N₄, TiO₂, and ZnO, to achieve efficient photodegradation of various water pollutants, including VOCs, dyes, antibiotics, and pesticides. The semi-metallic nature of 1T′-TMDs, with high electronic transport capability, could reduce electron-hole recombination, thereby enhancing the photodegradation efficiency.

This combination enhances their photocatalytic capabilities, allowing efficient degradation of various water pollutants. The dual functionality of water evaporation and pollutant degradation positions these materials as advanced solutions for next-generation water treatment systems.

In summary, the present invention successfully establishes phase-engineered 1T′-TMDs as intrinsically efficient and stable platforms for advanced solar-driven water purification. By leveraging the semimetallic nature of the 1T′ phase, the invention provides superior broadband solar harvesting and nonradiative relaxation pathways, as evidenced by long-lived carrier absorption and plasmonic bleaching. These electronic characteristics offer a decisive advantage over the rapidly decaying excitonic response of conventional 2H-phase materials, ensuring higher photothermal conversion efficiency and enhanced stability under ambient conditions.

The integration of 1T′-TMD nanosheets into a porous hydrogel matrix further yields significant thermodynamic benefits, particularly in reducing the water activation enthalpy through the enrichment of intermediate water species. This synergistic configuration achieves exceptionally high evaporation rates and solar-to-vapor efficiency, far exceeding those of existing TMD-based evaporators. Furthermore, the interconnected structural design provides robust salt tolerance and self-cleaning capabilities, allowing for continuous and stable freshwater production even under high-salinity conditions that typically cause fouling in traditional systems.

Beyond desalination, the invention enables a multifunctional hybrid system by coupling 1T′-TMDs with semiconductor catalysts. The high electronic transport capability of the 1T′ phase suppresses electron-hole recombination, thereby significantly boosting the photocatalytic degradation of organic contaminants such as phenol. This integration allows for the simultaneous production of purified water and the in-situ removal of pollutants without compromising performance. Consequently, the 1T′-phase TMD hydrogel serves as a scalable, durable, and cost-effective platform for next-generation environmental remediation and sustainable water management.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

References: The disclosures of the following references are incorporated by reference
1. Mechanically interlocked 1T/2H phases of MoS₂ nanosheets for solar thermal water purification. Nano Energy. 2018, 53, 949-957.
2. Stable metallic 1T phase engineering of molybdenum disulfide for enhanced solar vapor generation. Sol. Energ. Mat. Sol. C. 2020, 204, 110227.
3. US20220348476A1
4. CN112707391B
5. CN115746383A
6. Synthesis of an aqueous, air-stable, superconducting 1T′-WS₂ monolayer ink. Sci. Adv. 9, eadd6167 (2023).

1. A photothermal hydrogel for solar-driven water evaporation and pollutant removal, comprising:
a polymer matrix comprising an interconnected porous framework; and
semimetallic 1T′-phase transition metal dichalcogenide (1T′-TMD) nanosheets distributed within and anchored to the interconnected porous framework;
wherein the 1T′-TMD nanosheets are present in a concentration ranging from 0.5 wt % to 8 wt % based on the total weight of the hydrogel.

2. The photothermal hydrogel of claim 1, wherein the 1T′-TMD nanosheets comprise a transition metal M and a chalcogen X represented by a formula MX2, where M is selected from the group consisting of tungsten (W) and molybdenum (Mo), and X is selected from the group consisting of sulfur(S) and selenium (Se).

3. The photothermal hydrogel of claim 2, wherein the 1T′-TMD nanosheets comprise 1T′-phase tungsten disulfide (1T′-WS₂).

4. The photothermal hydrogel of claim 1, wherein the 1T′-TMD nanosheets have an average thickness ranging from 0.7 nm to 2.1 nm.

5. The photothermal hydrogel of claim 1, wherein the polymer matrix is selected from the group consisting of polyacrylic acid, polyvinyl alcohol, polyethylene glycol, sodium polyacrylate, polyacrylamide, polyethyleneimine, polystyrene sulfonic acid, and polystyrene sodium sulfonate.

6. The photothermal hydrogel of claim 1, wherein the photothermal hydrogel exhibits a solar absorptance of at least 0.9 across a wavelength range from 200 nm to 2000 nm in a dry state.

7. The photothermal hydrogel of claim 1, further comprising noble metal nanoparticles decorated on a surface of the 1T′-TMD nanosheets, and further comprising at least one semiconductor catalyst coupled to the 1T′-TMD nanosheets.

8. The photothermal hydrogel of claim 7, wherein the noble metal nanoparticles are silver (Ag) nanoparticles having an average particle size distributed between 5 nm and 20 nm.

9. A photocatalytic-photothermal composite system for solar-driven water evaporation and pollutant removal, comprising:
a hydrogel matrix comprising semimetallic 1T′-phase transition metal dichalcogenide (1T′-TMD) nanosheets integrated into a cross-linked polymer network; and
at least one semiconductor catalyst in direct interfacial contact with the 1T′-TMD nanosheets to form a semiconductor/1T′-TMD heterojunction,
wherein the heterojunction promotes charge carrier separation between the semiconductor catalyst and the 1T′-TMD nanosheets, and wherein the semimetallic 1T′-TMD nanosheets function as an electron sink.

10. The system of claim 9, wherein the at least one semiconductor catalyst is selected from the group consisting of graphitic carbon nitride, titanium dioxide, zinc oxide, iron oxide, bismuth oxyhalides and cadmium sulfide.

11. The system of claim 9, wherein the weight ratio of the at least one semiconductor catalyst to the 1T′-TMD nanosheets ranges from 5:1 to 50:1.

12. The system of claim 9, wherein the organic contaminants comprise volatile organic compounds (VOCs) selected from phenol, aniline, formaldehyde, benzene, and toluene.

13. The system of claim 9, wherein the system exhibits a photocatalytic degradation efficiency ranging from 80% to 99% for phenol under 1 sun irradiation for 60 minutes.

14. The system of claim 9, further comprising a water supply component arranged to transport source water to the hydrogel matrix via capillary action, wherein the hydrogel matrix is positioned at an air-water interface.

15. A method for preparing a 1T′-phase transition metal dichalcogenide (1T′-TMD)-based hydrogel, comprising the steps of:
synthesizing 1T′-phase crystals by heating a mixture comprising a 2H-phase TMD precursor, a potassium-based salt promoter, and a chalcogen source at a temperature between 700° C. and 900° C. under a reducing atmosphere;
exfoliating the 1T′-phase crystals to produce a suspension of 1T′-TMD nanosheets;
integrating the 1T′-TMD nanosheets into a hydrophilic polymer solution containing a cross-linking agent to form a mixture; and
subjecting the mixture to a freeze-thaw cycle to establish an interconnected porous structure while preserving the semimetallic 1T′-phase;
wherein the exfoliation yield of the 1T′-TMD nanosheets is at least 80% relative to the total mass of exfoliated nanosheets obtained from the 1T′-phase crystals.

16. The method of claim 15, wherein the exfoliating step is performed by sonication in an acidic solution, the acidic solution comprises H₂SO₄ at a concentration of 0.1 M to 1.0 M.

17. The method of claim 15, wherein the potassium-based salt promoter is selected from the group consisting of potassium oxalate, potassium oxalate monohydrate, potassium carbonate, and potassium bicarbonate, the chalcogen source is selected from the group consisting of sulfur(S) powder and selenium (Se) powder, and the 2H-phase TMD precursor is selected from the group consisting of WS₂ powder, MoS₂ powder, WSe₂ powder, and MoSe₂ powder.

18. The method of claim 15, wherein the salt promoter comprises potassium oxalate monohydrate, and the weight ratio of the 2H-phase TMD precursor to the salt promoter to the chalcogen source ranges from 1:0.5:1 to 1:1.5:2.

19. The method of claim 15, wherein the hydrophilic polymer solution comprises polyvinyl alcohol (PVA) at a concentration ranging from 100 mg/mL to 400 mg/mL.

20. The method of claim 15, wherein the cross-linking is performed using glutaraldehyde and an acid catalyst, wherein the concentration of the acid catalyst is maintained between 0.02 M and 0.1 M.
